(19) United States
(12) Patent Application Publication
(10) Pub. No.: US 2022/0279620 A1
(43) Pub. Date: Sep. 1, 2022

(54) Methods, Apparatus, and Machine-Readable Media Relating to Dual- or Multi-Connectivity in a Wireless Communication Network

(71) Applicant: Telefonaktiebolaget LM Ericsson (publ), Stockholm (SE)

(72) Inventors: Patrik Rugeland, Stockholm (SE); Lian Araujo, Solna (SE); Oumer Teyeb, Montréal (CA)

(21) Appl. No.: 17/627,833

(22) PCT Filed: Jul. 17, 2020
(86) PCT No.: PCT/EP2020/070360

§ 371 Date: Jan. 18, 2022

Related U.S. Application Data
(60) Provisional application No. 62/876,335, filed on Jul. 19, 2019.

(51) Int. Cl. H04W 76/36; H04W 76/10; H04W 76/25; H04W 76/27; H04W 72/12

(52) U.S. Cl. CPC H04W 76/36; H04W 76/10; H04W 76/25; H04W 76/27; H04W 72/1278

(57) ABSTRACT

A method is performed by a base station of a wireless communication network. The base station is configured as a secondary node for a wireless device having dual- or multi-connectivity to the wireless communication network via a master node and one or more secondary nodes comprising the base station. The method comprises: causing transmission of a message to the master node, the message comprising an indication that the base station is releasing resources associated with one or more layers of a radio connection between the base station and the wireless device.

### TECHNICAL FIELD

Embodiments of the disclosure relate to wireless communications, and particularly relate to methods, apparatus and machine-readable media in connection with dual- or multi-connectivity in a wireless communication network.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In 3GPP the dual-connectivity (DC) solution has been specified, both for Long Term Evolution (LTE) and New Radio (NR) separately, as well as between LTE and NR. In DC, two nodes are involved: a master node (MN) and a Secondary Node (SN). Multi-connectivity (MC) describes the general case where two or more nodes are involved (e.g., a master node and one or more secondary nodes). It is also known in the art for the term “multi-connectivity” to refer to scenarios in which more than two nodes are utilized, to distinguish from dual-connectivity. For the avoidance of doubt, embodiments of the present disclosure relate to both dual- and multi-connectivity scenarios.

DC or MC may be particularly useful for the transmission of Ultra Reliable Low Latency Communications (URLLC), in order to avoid connection interruptions and thus enhance the robustness of such communications. For example, URLLC data may be duplicated via multiple radio connections established with the wireless device, to increase the likelihood that the data is correctly received.

### SUMMARY

There currently exist certain challenge(s).

When a UE that was operating in DC is sent to INACTIVE state, it keeps the inactive access stratum (AS) UE context, which includes the full configuration of the UE's connections with both the MN and the SN (i.e. MCG and SCG configurations as well as higher layer configurations). In rel-15, the MN tells the SN to release the SCG configuration while keeping the higher layer configurations. For future releases, however, it may be possible to allow the SN to keep the SCG configuration while the UE is in INACTIVE mode and have the possibility to resume the UE with the stored SCG configuration. Alternatively or additionally, the SCG may be suspended (and thus the SCG configuration is kept at both the UE and the SN), while the UE is in CONNECTED state.

In either case (i.e. if SCG configuration was kept by the SN while the UE is INACTIVE state or SCG is suspended while the UE is in CONNECTED state), the SN may need to release the suspended SCG configuration for the UE (e.g. if it wants to admit another UE and free up resources that were reserved for the suspended UE). However, currently, there is no mechanism for the SN to inform the MN that the SCG configuration for a suspended UE should be released, while upper layer configurations are kept (as the SN triggered SN release releases the whole SN configuration, taking the UE out of DC operation and putting it into standalone mode). Consequently, the SN has either to keep the SCG configuration until the MN decides to release/resume the SCG e.g. upon resuming the UE, or release the whole SN configuration (higher and lower layers, i.e. normal SN release procedure) while the UE gets suspended, even though the SN may be able to keep the higher layer resources allocated to the UE (PDCP/SDAP).

One possible implementation to address this issue is to allow the SN to release the lower layer resources without informing the MN, which could alleviate the resource limitation at the SN. However, when the UE is resumed, it may try to resume the stored SCG configuration, which might lead to SCG failure as the lower-layer resources are no longer allocated for that UE at the SN.

A similar problem exists in the case of a UE in CONNECTED state with an active SCG, where the SN may want to release the SCG configurations while keeping the lower layer configurations, which is currently not possible.

Certain aspects of the present disclosure and their embodiments may provide solutions to these or other challenges. Solutions are proposed to allow the SN to inform the MN to release only the SCG configuration (i.e. SCG lower layer configurations) while the upper layer SN configurations/resources are kept. This process may be triggered due to resource limitations at the SN, where the SN has to allocate resources to new or existing UEs that have an active connection with it.

As described below, these methods are mainly applied in the context of a UE in INACTIVE mode (or in CONNECTED mode with suspended SCG configuration), but they are not limited to it. The methods may be used even when the UE is in CONNECTED mode, and where both the MCG and SCG are active.

Solutions are also proposed to allow the SN to inform the MN to re-add the lower layer SCG configurations/resources for a UE, for which the SN has previously informed the MN to release the SCG resources (e.g., in case more resources become available at the SN). This is especially useful in the case where the UE is in INACTIVE mode (or has its SCG suspended) for a long period of time as resources can be given temporarily to other UEs while the UE is in INACTIVE mode. By the time the UE resumes (e.g., enters CONNECTED mode), if the resources are still being used by other UEs (i.e. SCG has been released but not re-added), then the MN can instruct the UE to release the SCG or configure it with another SN/SCG configuration. On the other hand, if the resources have been re-added, after being released temporarily, then the MN can instruct the UE to resume the SCG. The process of releasing and re-adding SCG resources may have happened while the UE is in INACTIVE mode (or has its SCG suspended) and thus is completely transparent to the UE, thereby avoiding unnecessary signaling over the air interface and UE processing.

There are, proposed herein, various embodiments which address one or more of the issues disclosed herein.

In one aspect, the disclosure provides a method performed by a base station of a wireless communication network. The base station is configured as a secondary node for a wireless device having dual- or multi-connectivity to the wireless communication network via a master node and one or more secondary nodes comprising the base station. The method comprises: causing transmission of a message to the master node, the message comprising an indication that the base station is releasing resources associated with one or more layers of a radio connection between the base station and the wireless device.

In a second aspect, the disclosure provides a method performed by a base station of a wireless communication network. The base station is configured as a secondary node for a wireless device having dual- or multi-connectivity to the wireless communication network via a master node and one or more secondary nodes comprising the base station. The method comprises: receiving, from the master node, a message comprising a first indication that a radio connection between the base station and the wireless device is suspended, and a second indication of a time period for which the base station is to maintain an allocation of resources associated with one or more layers of the radio connection between the base station and the wireless device despite the suspension of that radio connection.

In a third aspect, the disclosure provides a method performed by a base station of a wireless communication network. The base station is configured as a master node for a wireless device having dual- or multi-connectivity to the wireless communication network via the base station and one or more secondary nodes The method comprises: receiving a message from a secondary node of the one or more secondary nodes, the message comprising an indication that the secondary node is releasing resources associated with one or more layers of a radio connection between the secondary node and the wireless device.

In a fourth aspect, the disclosure provides a method performed by a base station of a wireless communication network. The base station is configured as a master node for a wireless device having dual- or multi-connectivity to the wireless communication network via the base station and one or more secondary nodes. The method comprises: causing transmission, to a secondary node of the one or more secondary nodes, of a message comprising a first indication that a radio connection between the secondary node and the wireless device is suspended, and a second indication of a time period for which the secondary node is to maintain an allocation of resources associated with one or more layers of the radio connection between the secondary node and the wireless device despite the suspension of that radio connection.

Certain embodiments may provide one or more of the following technical advantage(s). With the methods proposed in this disclosure, the SN is provided with the autonomy to decide until when to keep the SCG configuration/resources (i.e. lower layer configuration/resources) allocated/reserved for a UE, while still being able to keep the higher layer resources.

The solutions also allow the possibility for resources allocated to the SCG for a first UE to be temporarily allocated to other UEs while the first UE is in INACTIVE mode or has its SCG suspended, and the re-assigned to the first UE before it enters CONNECTED mode, thereby making the whole method transparent from the UE's perspective, and avoiding unnecessary air interface signaling and UE processing overhead.

### BRIEF DESCRIPTION OF THE DRAWINGS

FIG. 1 shows the 5G system architecture;

FIG. 2 shows different interworking options for LTE and NR;

FIG. 3 is a signalling diagram showing an SN addition procedure;

FIG. 4 is a signalling diagram showing an MN-initiated SN release procedure;

FIG. 5 is a signalling diagram showing an SN-initiated SN release procedure;

FIG. 6 is a signalling diagram showing Activity notification;

FIG. 7 is a signalling diagram showing support of Activity notification while a UE is in RRC-Inactive mode;

FIG. 8 is a diagram showing signalling according to embodiments of the disclosure;

FIG. 9 shows a wireless network according to embodiments of the disclosure;

FIG. 10 shows a user equipment;

FIG. 11 shows a virtualization environment according to embodiments of the disclosure;

FIG. 12 shows a telecommunication network according to embodiments of the disclosure;

FIG. 13 shows a host computer communicating via a base station with a user equipment according to embodiments of the disclosure;

FIGS. 14 to 17 are flowcharts of methods according to embodiments of the disclosure;

FIG. 18 is a flowchart of a method according to embodiments of the disclosure;

FIG. 19 shows a virtual apparatus according to embodiments of the disclosure;

FIG. 20 is a flowchart of a method according to further embodiments of the disclosure; and

FIG. 21 shows a virtual apparatus according to further embodiments of the disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

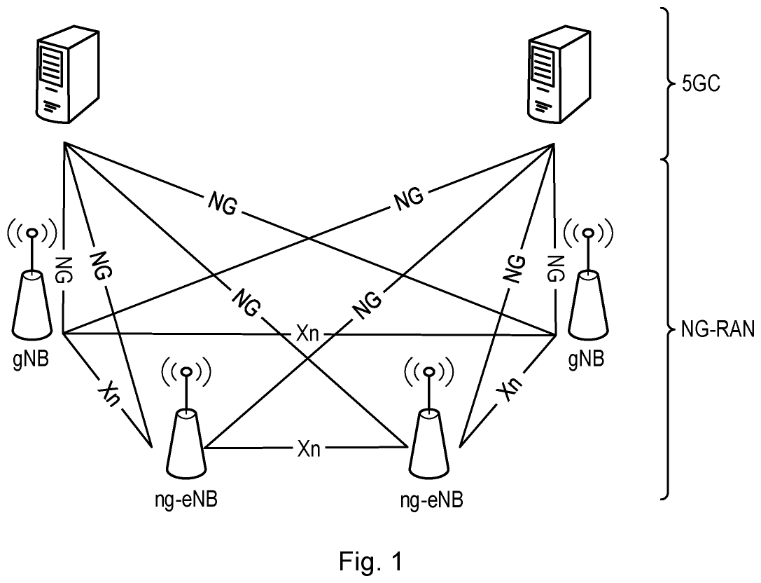

3GPP is developing fifth generation standards known as 5G. The current standards introduce both a new core network (5GC) and a new Radio Access Network (NG-RAN). The latter utilizes a radio standard known as New Radio (NR). The core network 5GC may also support radio access technologies (RATs) other than NR. For example, it has been agreed that LTE (or evolved Universal Terrestrial Radio Access, E-UTRA) should also be connected to 5GC. LTE base stations (eNBs) that are connected to 5GC are called ng-eNB and are part of NG-RAN. NG-RAN may also comprise NR base stations called gNBs. FIG. 1 shows how the base stations in NG-RAN are connected to each other and the nodes and 5GC.

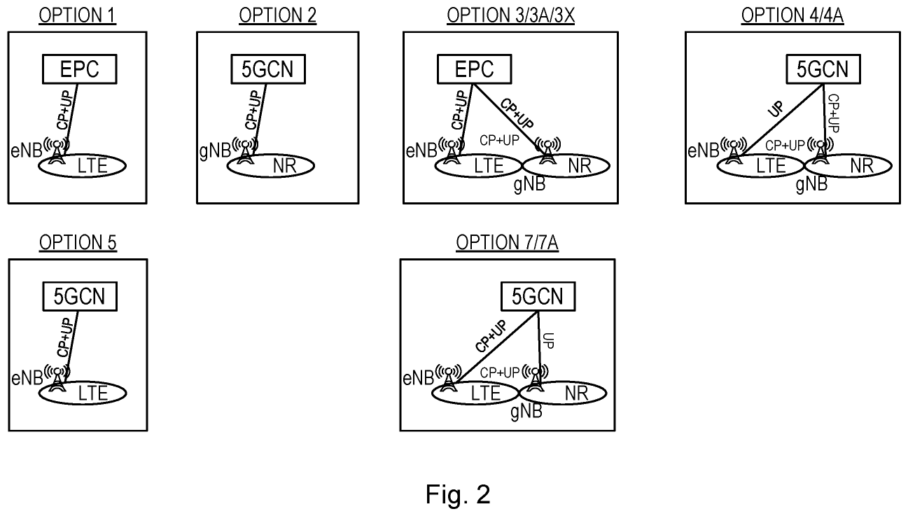

There are a number of different ways in which to deploy 5G networks, with or without interworking with LTE (also referred to as E-UTRA) and evolved packet core (EPC), as depicted in FIG. 2. In principle, NR and LTE can be deployed without any interworking, denoted by NR stand-alone (SA) operation, i.e., gNB in NR can be connected to 5G core network (5GC) and eNB can be connected to EPC with no interconnection between the two (Option 1 and Option 2 in FIG. 2). On the other hand, the first supported version of NR is the so-called EN-DC (E-UTRAN-NR Dual Connectivity), illustrated by Option 3. In such a deployment, dual connectivity between NR and LTE is applied with LTE as the master node and NR as the secondary node. The RAN node (gNB) supporting NR may not have a control plane connection to the core network (EPC); instead it relies on the LTE as master node (MeNB). This is also called as “Non-standalone NR”. In this case the functionality of an NR cell may be limited and would be used for connected mode UEs to boost data rates and/or to provide greater transmit diversity, but an RRC_IDLE UE cannot camp on these NR cells.

With the introduction of 5GC, other options may also be valid. As mentioned above, option 2 supports stand-alone NR deployment where gNB is connected to 5GC. Similarly, LTE can also be connected to 5GC using option 5 (also known as eLTE, E-UTRA/5GC, or LTE/5GC and the node can be referred to as an ng-eNB). In these cases, both NR and LTE are seen as part of the NG-RAN (and both the ng-eNB and the gNB can be referred to as NG-RAN nodes). It is worth noting that Option 4 and option 7 are other variants of dual connectivity between LTE and NR which will be standardized as part of NG-RAN connected to 5GC, denoted by MR-DC (Multi-Radio Dual Connectivity). Under the MR-DC umbrella, we have:
EN-DC (Option 3): LTE is the master node and NR is the secondary node (EPC CN employed)
NE-DC (Option 4): NR is the master node and LTE is the secondary node (SGCN employed)
NGEN-DC (Option 7): LTE is the master node and NR is the secondary node (SGCN employed)
NR-DC (variant of Option 2): Dual connectivity where both the master and secondary nodes are NR (SGCN employed).

As migration for these options may differ from different operators, it is possible to have deployments with multiple options in parallel in the same network e.g. there could be an eNB base station supporting option 3, 5 and 7 in the same network as an NR base station supporting options 2 and 4. In combination with dual connectivity solutions between LTE and NR, it is also possible to support CA (Carrier Aggregation) in each cell group (i.e. master cell group (MCG) and secondary cell group (SCG)) and dual connectivity between nodes using the same RAT (e.g. NR-NR DC). For the LTE cells, a consequence of these different deployments is the co-existence of LTE cells associated with eNBs connected to EPC, 5GC or both EPC/5GC.

The general operations related to MR-DC are captured in TS 37.340, v 15.6.0, and the ones related to MR-DC with 5GC are reproduced in the following text (while for EN-DC, procedures differ slightly and can be found in clause 10 from TS 37.340, v 15.6.0).

Throughout this text, the following terminologies are used,
“SCG configuration” is used to refer to the SN lower layer configuration, i.e. (RLC, MAC and PHY).
“SN configuration” is used to refer to the configuration related to the whole SN, i.e. the SCG configuration which contains the lower layer information as well as higher layers (i.e. Service Data Adaptation Protocol (SDAP) and Packet Data Convergence Protocol (PDCP))

The following passages describe various processes regarding the interaction of a master node and a secondary node in a dual- or multi-connectivity configuration, as set out in current standards. First, the process for adding a secondary node is described; then the process for released a secondary node (as initiated by the master node or the secondary node); then the process for modifying a secondary node (as initiated by the master node or the secondary node); and then the process for notifying the master node of UE inactivity.

### Secondary Node Addition

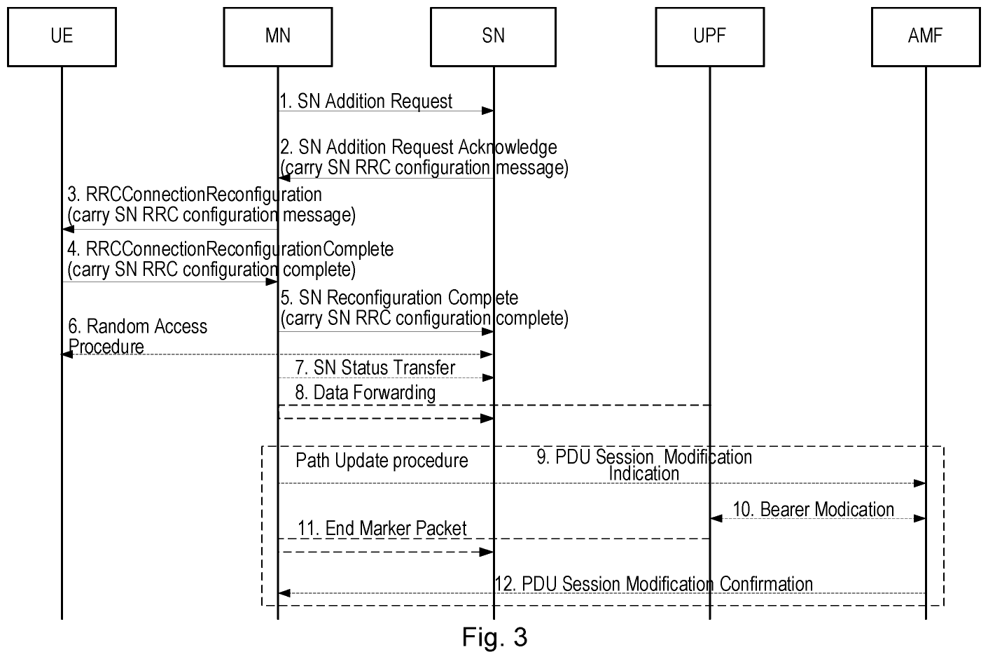

The Secondary Node (SN) Addition procedure is initiated by the MN and is used to establish a UE context at the SN in order to provide radio resources from the SN to the UE. For bearers requiring SCG radio resources, this procedure is used to add at least the initial SCG serving cell of the SCG. This procedure can also be used to configure an SN terminated MCG bearer (where no SCG configuration is needed). FIG. 3 shows the SN Addition procedure.

1. The MN decides to request the target SN to allocate radio resources for one or more specific Protocol Data Unit (PDU) Sessions or Quality of Service (QoS) Flows, indicating QoS Flows characteristics (QoS Flow Level QoS parameters, PDU session level Transport Network Layer (TNL) address information, and PDU session level Network Slice info). In addition, for bearers requiring SCG radio resources, MN indicates the requested SCG configuration information, including the entire UE capabilities and the UE capability coordination result. In this case, the MN also provides the latest measurement results for SN to choose and configure the SCG cell(s). The MN may request the SN to allocate radio resources for split Signalling Radio Bearer (SRB) operation. The MN always provides all the needed security information to the SN (even if no SN terminated bearers are setup) to enable SRB3 to be setup based on SN decision. For bearer options that require Xn-U resources between the MN and the SN, MN needs to provide Xn-U TNL address information, Xn-U DL TNL address information for SN terminated bearers and Xn-U UL TNL address information for MN terminated bearers. The SN may reject the request.

NOTE 1: For split bearers, MCG and SCG resources may be requested of such an amount, that the QoS for the respective QoS Flow is guaranteed by the exact sum of resources provided by the MCG and the SCG together, or even more. For MN terminated split bearers, the MN decision is reflected in step 1 by the QoS Flow parameters signalled to the SN, which may differ from QoS Flow parameters received over NG.

NOTE 2: For a specific QoS flow, the MN may request the direct establishment of SCG and/or split bearers, i.e. without first having to establish MCG bearers. It is also allowed that all QoS flows can be mapped to SN terminated bearers, i.e. there is no QoS flow mapped to an MN terminated bearer.

2. If the Radio Resource Management (RRM) entity in the SN is able to admit the resource request, it allocates respective radio resources and, dependent on the bearer type options, respective transport network resources. For bearers requiring SCG radio resources the SN triggers UE Random Access so that synchronisation of the SN radio resource configuration can be performed. The SN decides for the PScell and other SCG Scells and provides the new SCG radio resource configuration to the MN in a SN Radio Resource Configuration (RRC) configuration message contained in the SN Addition Request Acknowledge message. In case of bearer options that require Xn-U resources between the MN and the SN, the SN provides Xn-U TNL address information for the respective E-RAB (E-UTRAN Radio Access Bearer), Xn-U UL TNL address information for SN terminated bearers, Xn-U DL TNL address information for MN terminated bearers. For SN terminated bearers, the SN provides the NG-U DL TNL address information for the respective PDU Session and security algorithm. If SCG radio resources have been requested, the SCG radio resource configuration is provided.

NOTE 3: In case of MN terminated bearers, transmission of user plane data may take place after step 2.

NOTE 4: In case of SN terminated bearers, data forwarding and the SN Status Transfer may take place after step 2.

NOTE 5: For MN terminated NR SCG bearers for which PDCP duplication with CA is configured the MN allocates 2 separate Xn-U bearers.

For SN terminated NR MCG bearers for which PDCP duplication with CA is configured the SN allocates 2 separate Xn-U bearers.

3. The MN sends the MN RRC reconfiguration message to the UE including the SN RRC configuration message, without modifying it.

4. The UE applies the new configuration and replies to MN with MN RRC reconfiguration complete message, including a SN RRC response message for SN, if needed. In case the UE is unable to comply with (part of) the configuration included in the MN RRC reconfiguration message, it performs the reconfiguration failure procedure.

5. The MN informs the SN that the UE has completed the reconfiguration procedure successfully via SN Reconfiguration Complete message, including the encoded SN RRC response message, if received from the UE.

6. If configured with bearers requiring SCG radio resources, the UE performs synchronisation towards the PSCell configured by the SN. The order the UE sends the MN RRC reconfiguration complete message and performs the Random Access procedure towards the SCG is not defined. The successful RA procedure towards the SCG is not required for a successful completion of the RRC Connection Reconfiguration procedure.

7. In case of SN terminated bearers using Radio Link Control (RLC) Acknowledged Mode (AM_, the MN sends SN Status Transfer.

8. In case of SN terminated bearers using RLC AM, and dependent on the bearer characteristics of the respective QoS Flows, the MN may take actions to minimise service interruption due to activation of MR-DC (Data forwarding).

9-12. For SN terminated bearers, the update of the UP path towards the 5GC is performed via PDU Session Path Update procedure.

The release of the whole SN configuration, i.e. including any current configuration—either higher layers (PDCP, or PDCP and SDAP for user plane) and/or lower layers (RLC, MAC and PHY)—is performed via the SN release procedure. Alternatively, the MN can, upon deciding to send the UE to RRC_INACTIVE state, send an indication for the SN to release solely its lower layer configuration, i.e. higher layer configuration, if any, can be kept.

### Secondary Node Release (MN/SN Initiated)

The SN Release procedure may be initiated either by the MN or by the SN and is used to initiate the release of the UE context and relevant resources at the SN. The recipient node of this request can reject it, e.g., if a SN change procedure is triggered by the SN.

### MN Initiated SN Release

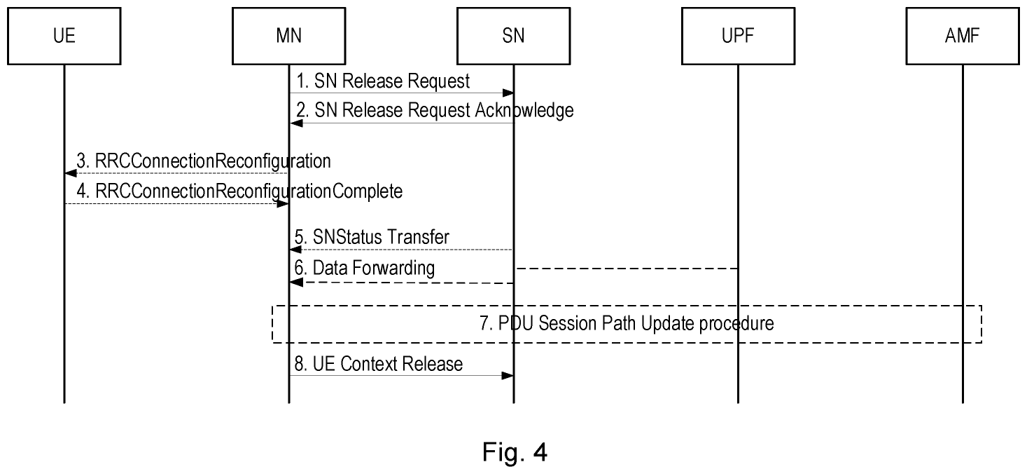

FIG. 4 shows an example signalling flow for the MN initiated SN Release procedure.

1. The MN initiates the procedure by sending the SN Release Request message. If data forwarding is requested, the MN provides data forwarding addresses to the SN.

2. The SN confirms SN Release by sending the SN Release Request Acknowledge message. If appropriate, the SN may reject SN Release, e.g., if the SN change procedure is triggered by the SN.

3/4. If required, the MN indicates in the MN RRC reconfiguration message towards the UE that the UE shall release the entire SCG configuration. In case the UE is unable to comply with (part of) the configuration included in the MN RRC reconfiguration message, it performs the reconfiguration failure procedure.

NOTE 1: If data forwarding is applied, timely coordination between steps 1 and 2 may minimize gaps in service provision, this is however regarded to be an implementation matter.

5. If the released bearers use RLC AM, the SN sends the SN Status transfer.

6. Data forwarding from the SN to the MN takes place.

7. If applicable, the PDU Session path update procedure is initiated.

8. Upon reception of the UE Context Release message, the SN can release radio and C-plane related resource associated to the UE context. Any ongoing data forwarding may continue.

### SN Initiated SN Release

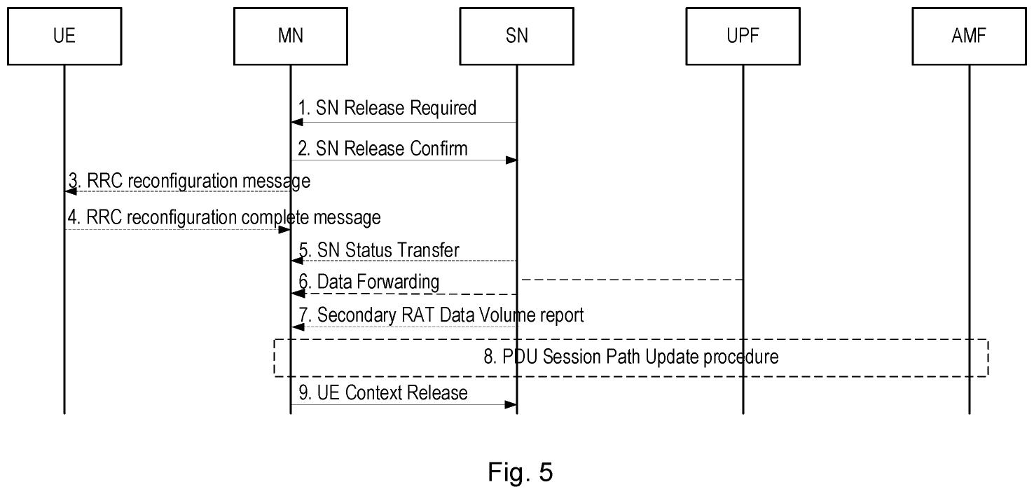

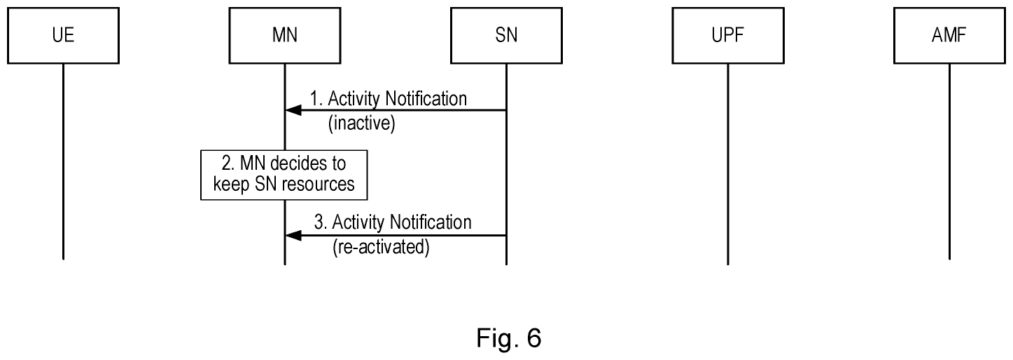

FIG. 5 shows an example signalling flow for the SN initiated SN Release procedure.

1. The SN initiates the procedure by sending the SN Release Required message which does not contain any inter-node message.

2. If data forwarding is requested, the MN provides data forwarding addresses to the SN in the SN Release Confirm message. The SN may start data forwarding and stop providing user data to the UE as early as it receives the SN Release Confirm message.

3/4. If required, the MN indicates in the MN RRC reconfiguration message towards the UE that the UE shall release the entire SCG configuration. In case the UE is unable to comply with (part of) the configuration included in the MN RRC reconfiguration message, it performs the reconfiguration failure procedure.

NOTE 2: If data forwarding is applied, timely coordination between steps 2 and 3 may minimize gaps in service provision. This is however regarded to be an implementation matter.

5. If the released bearers use RLC AM, the SN sends the SN Status transfer.

6. Data forwarding from the SN to the MN takes place.

7. The SN sends the Secondary RAT Data Volume Report message to the MN and includes the data volumes delivered to the UE as described in section 10.11.2.

NOTE 3: The order the SN sends the Secondary RAT Data Volume Report message and performs data forwarding with MN is not defined. The SN may send the report when the transmission of the related QoS flow is stopped.

8. If applicable, the PDU Session path update procedure is initiated.

9. Upon reception of the UE Context Release message, the SN can release radio and C-plane related resource associated to the UE context. Any ongoing data forwarding may continue.

The Activity Notification function is used to report user plane activity within SN resources. It can either report inactivity or resumption of activity after inactivity was reported. In MR-DC with 5GC the Activity Reporting is provided from the SN only. The MN may take further actions.

### MR-DC With 5GC Activity Notification

1. The SN notifies the MN about user data inactivity.

2. The MN decides further actions that impact SN resources (e.g. send UE to RRC_INACTIVE, bearer reconfiguration). In the case shown, MN takes no action.

3. The SN notifies the MN that the (UE or PDU Session or QoS flow) is no longer inactive.

The Activity Notification function may be used to enable MR-DC with 5GC with RRC_INACTIVE operation. The MN node may decide, after inactivity is reported from the SN and also MN resources show no activity, to send the UE to RRC_INACTIVE. Resumption to RRC_CONNECTED may take place after activity is reported from the SN for SN terminated bearers.

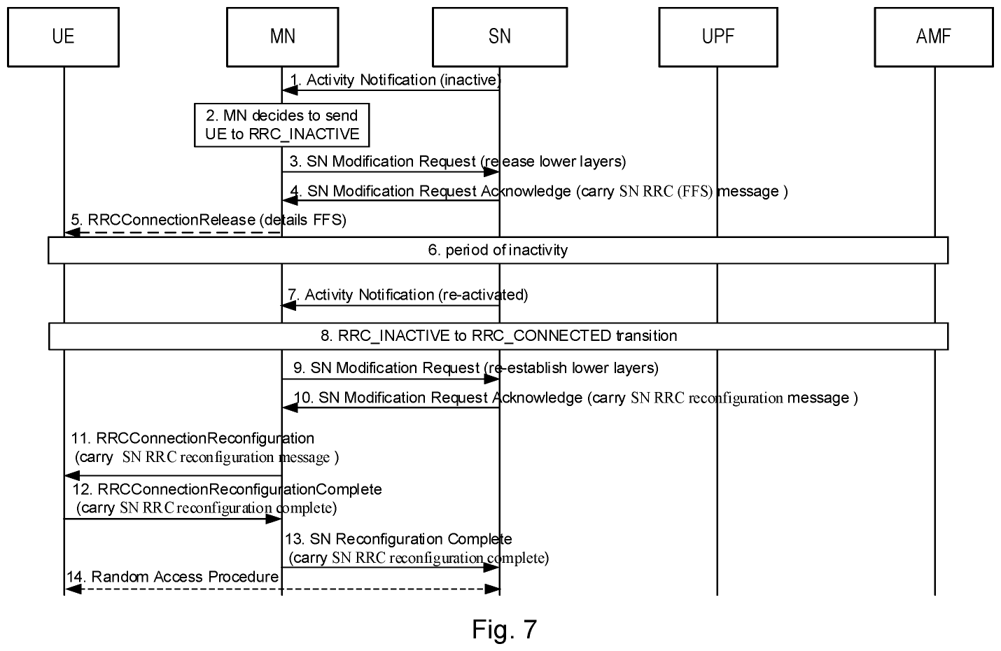

FIG. 7 shows how Activity Notification function interacts with NG-RAN functions for RRC_INACTIVE and SN Modification procedures in order to keep the higher layer MR-DC configuration established for UEs in RRC_INACTIVE, including NG and Xn interface C-plane, U-plane and bearer contexts established while lower layer MCG and SCG resources are released. When the UE transits successfully back to RRC_CONNECTED, lower layer MCG and SCG resources are established afterwards by means of RRC Connection Reconfiguration.

1. The SN notifies the MN about user data inactivity for SN terminated bearers.

2. The MN decides to send the UE to RRC_INACTIVE.

3/4. The MN triggers the MN initiated SN Modification procedure, requesting the SN to release lower layers.

5. The UE is sent to RRC_INACTIVE.

6-8. After a period of inactivity, upon activity notification from the SN, the UE returns to RRC_CONNECTED.

9/10. The MN triggers the MN initiated SN Modification procedure to re-establish lower layers. The SN provides configuration data within an SN RRC configuration message.

11-14. The RRCConnectionReconfiguration procedure commences.

In 38.423 v15.3.0, the modification of the SN triggered by the MN is defined in an S-NODE MODIFICATION REQUEST message. As shown in the procedures above, for the UE sent by the network from RRC_CONNECTED to RRC_INACTIVE, the MN has also to send an indication for the SN to release its lower layers, i.e., SCG configuration. The IE responsible for this indication is Lower Layer Presence Status Indication, and the value of the field is set to is set to “release lower layers”. When sending the UE from RRC_INACTIVE to RRC_CONNECTED, the MN sends S-NODE MODIFICATION REQUEST to the SN including the aforementioned IE (with the value set to “re-establish lower layers”) to indicate that the SN should generate an SCG configuration again.

As noted above, when a UE that was operating in DC is sent to INACTIVE state, it keeps the inactive access stratum (AS) UE context, which includes the full configuration of the UE's connections with both the MN and the SN (i.e. MCG and SCG configurations as well as higher layer configurations). In rel-15, the MN tells the SN to release the SCG configuration while keeping the higher layer configurations. For future releases, however, it may be possible to allow the SN to keep the SCG configuration while the UE is in INACTIVE mode and have the possibility to resume the UE with the stored SCG configuration. Alternatively or additionally, the SCG may be suspended (and thus the SCG configuration is kept at both the UE and the SN), while the UE is in CONNECTED state.

In either case (i.e. if SCG configuration was kept by the SN while the UE is INACTIVE state or SCG is suspended while the UE is in CONNECTED state), the SN may need to release the suspended SCG configuration for the UE (e.g. if it wants to admit another UE and free up resources that were reserved for the suspended UE). However, currently, there is no mechanism for the SN to inform the MN that the SCG configuration for a suspended UE should be released, while upper layer configurations are kept (as the SN triggered SN release releases the whole SN configuration, taking the UE out of DC operation and putting it into standalone mode). Consequently, the SN has either to keep the SCG configuration until the MN decides to release/resume the SCG e.g. upon resuming the UE, or release the whole SN configuration (higher and lower layers, i.e. normal SN release procedure) while the UE gets suspended, even though the SN may be able to keep the higher layer resources allocated to the UE (PDCP/SDAP).

The embodiments described below are mainly described in the context of a UE which is in INACTIVE mode or in CONNECTED mode with the SCG suspended. However, the methods are equally applicable to other scenarios, such as the case where the UE is in IDLE mode with suspended state (e.g. the UE was in EN-DC, where the MN is an LTE eNB connected to EPC, and it has been sent to the IDLE with suspended state); or for a UE in CONNECTED mode, where both the MCG and SCG are active.

Further, it will be understood that embodiments of the disclosure are applicable to all MR-DC cases (e.g., as set out above in FIG. 2).

### SN Triggered Releasing and Re-Establishing of SCG for a UE

According to a first embodiment of the disclosure, if the SN decides to no longer keep SCG resources for a UE, e.g. due to high load on the SN, it can initiate a procedure towards the MN to request for the release of the SCG. This may not require any RRC message to be generated by the SN and taken into account by the MN. The SCG release would imply that the MN would have to release SCG resources, which is already possible by current RRC signaling. In case the SN indication to release SCG concerns an INACTIVE UE or a UE in CONNECTED mode but with a suspended SCG configuration, the MN could release the SCG upon resuming the UE (e.g., upon the UE entering CONNECTED mode or resuming the suspended SCG configuration).

For example, the secondary node may transmit a message such as an S-NODE MODIFICATION REQUIRED message to the master node (equivalently known as the SN Modification required message). This message is described in 3GPP 38.423 v15.3.0, but may be modified according to embodiments of the disclosure to include an indication that the SCG resources for a given UE are being released. Note that the use of the present tense here and throughout is not limiting on the scope of the disclosure; the indication may equivalently indicate that the SCG resources have been released, or that they will be released.

For example, the S-NODE MODIFICATION REQUIRED message may be modified to include an information element (IE) such as a “Lower Layer presence status change” information element. The Lower Layer presence status change IE includes possible values “release lower layers”, and “re-establish lower layers”. The SN may set the value of the field to “release lower layers” to indicate that the SN is releasing the lower layers. Alternatively, new values may be introduced to avoid confusion as to which values are relevant in the messages from the MN to the SN and which are from the SN to the MN. In a further alternative embodiment, a new IE may be defined instead of the Lower Layer Presence Status Change to communicate the release of lower layers from the SN to the MN.

A further enhancement could be considered where the indication of the release of the SCG from the SN is not a final release but only a temporary one, such that the resources can be re-allocated to the UE later. In such an embodiment, after firstly sending S-NODE MODIFICATION REQUIRED with Lower Layer presence status change IE (or the newly introduced IE for this purpose) with value set to “release lower layers”, the SN may further update the MN by sending S-NODE MODIFICATION REQUIRED with Lower Layer presence status change IE (or the newly introduced IE for this purpose), with value “re-establish lower layers”. When the master node receives the release lower layer indication, and the UE is either in INACTIVE mode or in CONNECTED mode with SCG suspended, the MN may refrain from taking any action (such as notifying the UE) until the UE is configured into CONNECTED mode or the SCG has to be resume for some other reason (e.g. UL data arrival to a bearer that is associated with the SCG). If that happens, then the MN may reconfigure the UE in order to release the SCG or change the SCG/SN. However, if the MN receives an SN modification required message from the SN indicating re-establish lower layers before the UE is sent to CONNECTED mode or the SCG has to be resumed, then the MN can ignore the previous indication to release the SCG. That is, if the UE is put to CONNECTED mode, the MN can just indicate to the UE to resume/restore the stored SCG. The SCG resources may be released and re-established one or more times between the MN and SN without affecting the UE.

### Timer Dependent Release or Keeping of SCG Configurations

According to a second aspect of the disclosure, when the MN indicates to the SN to suspend the SCG (either when the UE goes to INACTIVE state or if the SCG is to be suspended while the UE is in CONNECTED state), the MN may transmit to the SN an optional IE indicating the duration for which the SN is to keep the SCG configuration/resources for that UE.

The indication may comprise an information element such as the Lower Layer presence status change IE. When the value of this IE is set to suspend scg but keep lower layers, then the SN will know that the UE is being sent to INACTIVE mode while the SCG is being kept (or the SCG is being suspended while the UE is in CONNECTED mode). A further indication may be provided (e.g., in a second IE, such as an inactivity duration IE) as to how long the UE is expected to be in the INACTIVE state (and thus for how long the SN has to keep the SCG resources even though the UE is not actively using them).

In a further embodiment, SN may provide an indication as to how long it can keep the SCG resources. For example, the indication may be provided in a SN Modification Request Acknowledge message transmitted responsive to receipt of the SN Modification Request message from the MN. The SN may respond confirming that it can keep the SCG resources for the requested duration by specifying a duration equal to or greater than the requested resources.

The MN may initiate a timer set to expire after the duration specified by the SN. If the UE is to be resumed from the INACTIVE state (or the SCG is to be resumed, if only the SCG was suspended while the UE is in the CONNECTED state) before this timer expires, the MN will know that it can resume the UE with its suspended SCG configuration; conversely, if the timer has expired, the MN will know that it should indicate to the UE to release the SCG configuration upon resuming the SCG for the UE or moving the UE to the CONNECTED state.

The specified duration (for which the SN intends to maintain the SCG resources) may be modified by the SN after its initial transmission to the MN. For example, an updated value of the duration may be indicated in further messages transmitted by the SN to the MN, such as a S-NODE MODIFICATION REQUIRED message (also known as SN Modification Required) or a NOTIFICATION CONTROL INDICATION message.

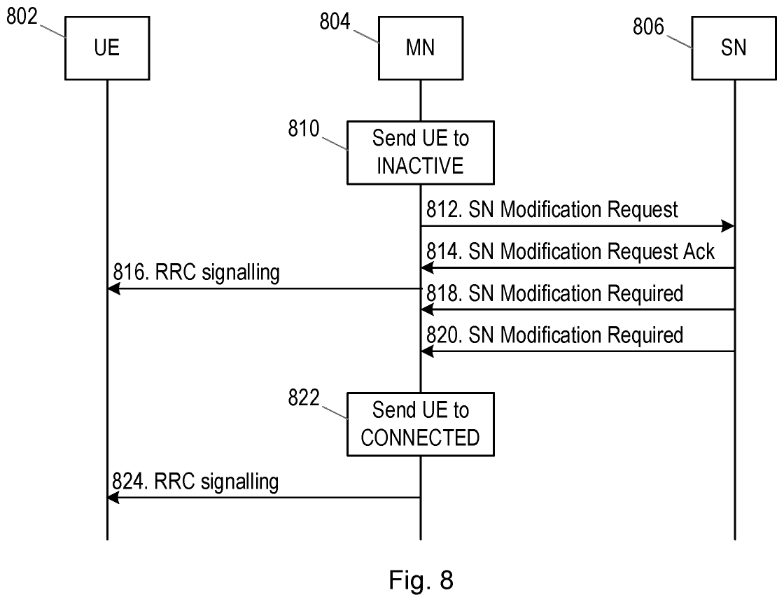

Thus the present disclosure provides two aspects by which a secondary node can inform a master node about the release of SCG resources for a particular UE configured with dual- or multi-connectivity. These aspects may be implemented separately from each other, as set out above and in the enumerated embodiments listed below. However, those skilled in the art will appreciate that the aspects are not mutually exclusive and thus may be implemented in combination. FIG. 8 is a signalling diagram showing both aspects of the disclosure.

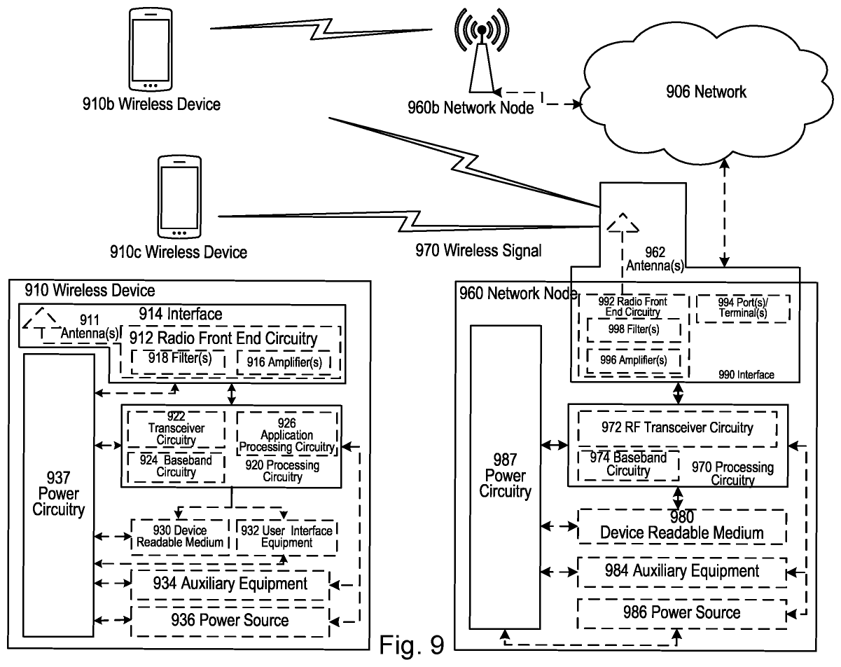

The signalling is performed by a wireless device or UE 802, a master node (MN) 804 and a secondary node (SN) 806 in a wireless communication network. As noted above, the wireless device 802 is configured with dual- or multi-connectivity connection to the network and thus, although only a single SN is shown, it will be appreciated that there may be more than one secondary node. The master node 804 and the secondary node 806 may be base stations or any other network node (such as the network nodes 960 illustrated in FIG. 9).

In the illustrated embodiment, in step 810, the MN 804 decides to send the wireless device 802 to an inactive mode, such as RRC_INACTIVE. Such a decision may be triggered by a detection of UE inactivity, either by the MN 804 or the SN 806 (e.g., as explained above under the heading, “MR-DC with 5GC Activity Notification”). In alternative embodiments, the MN 804 may decide only to suspend only the SCG, but otherwise to leave the wireless device 802 in an active mode (such as RRC_CONNECTED). In yet further alternative embodiments, step 810 (as well as steps 812, 814 and 816, described below) may be omitted entirely, with the wireless device 802 remaining in the active mode throughout.

In step 812, the MN 804 transmits a first message to the SN 806. The first message may be transmitted via a direct interface, such as the Xn interface (and all messages described herein as being transmitted between the MN and the SN may be so transmitted). The first message may comprise an SN Modification Request message (also known as an S-NODE Modification Request message). The first message may comprise a first indication that a radio connection between the secondary node and the wireless device is suspended (or is to be suspended). Optionally, as per the second aspect described above, the first message may also comprise a second indication of a time period for which the secondary node is to maintain an allocation of resources associated with one or more layers of the radio connection between the secondary node and the wireless device despite the suspension of that radio connection. The one or more layers may comprise only a subset of the layers of the radio connection, such as an integer number of the lowest or lower layers, or an integer number of the highest or higher layers. The lower layers may comprise one or more of: a radio link control, RLC, layer; a medium access control, MAC, layer; and a physical, PHY, layer. The higher layers may comprise one or more of: a packet data convergence protocol, PDCP, layer; and a service data adaptation protocol, SDAP, layer.

One example portion of the first message (e.g., SN Modification Request) is shown below.

| | | | | | | |
|---|---|---|---|---|---|---|
| | | | IE type and | Semantics | | Assigned |
| IE/Group Name | Presence | Range | reference | description | Criticality | Criticality |

| | | | | |
|---|---|---|---|---|
| >Lower Layer presence | O | 9.2.3.60 | | — |
| status change | | | | |
| >Inactivity duration | O | ENUMERATED | In case the SCG is being | |
| | | (sec15, sec30, sec60, | suspended and lower | |
| | | sec90, sec120, | layer SCG is being kept, | |
| | | sec180, sec 360, sec | this timer indicates the | |
| | | 720, sec1440, long- | amount of time the UE is | |
| | | time, . . .) | expected to be in | |
| | | | INACTIVE state or has its | |
| | | | SCG suspended, | |
| | | | indicating for how long the | |
| | | | SN is expected to keep | |
| | | | the SCG resources while | |
| | | | the UE is in INACTIVE or | |
| | | | has its SCG suspended. | |
| | | | If “long-time” is included, | |
| | | | the duration is expected to | |
| | | | be longer than 1440 | |
| | | | seconds. | |

The Lower Layer presence status change I E may be defined as follows:

| | | | IE type and | |
|---|---|---|---|---|
| IE/Group Name | Presence | Range | reference | Semantics description |
| Lower Layer presence | M | | ENUMERATED | “re-establish lower layers” shall be only set |
| status change | | | (release lower | after “release lower layers” has been |
| | | | layers, re- | indicated. |
| | | | establish lower | |
| | | | layers, suspend | |
| | | | scg but keep | |
| | | | lower layers, . . .) | |

Thus the first indication may comprise the Lower Layer presence status change IF, set to a particular value indicating to suspend the SCG but to keep resources allocated for the one or more layers (such as the lower layers). The inactivity duration IE may be set to one of a plurality of possible values, each defining a different duration of time for which the SN 806 is expected to maintain resources for the one or more layers.

In step 814, the SN transmits a second message to the MN 804. The second message may comprise an SN Modification Request Acknowledgement message (also known as an S-NODE Modification Request Acknowledgement message). The second message may comprise an indication of a time period for which the secondary node 806 intends to maintain the allocation of resources associated with one or more layers of the radio connection between the secondary node 806 and the wireless device 802.

One example portion of the second message (e.g., SN Modification Request Acknowledge) is shown below. Note the Resource reservation duration IF, which provides the indication of the duration of time for which the secondary node 806 intends to maintain the allocation of resources associated with one or more layers of the radio connection between the secondary node 806 and the wireless device 802. The indication may comprise the actual value of the time period, or one of a plurality of an index values which is interpreted by the MN 806 as corresponding to a particular time period (e.g., through pre-configuration).

| | | | | | | |
|---|---|---|---|---|---|---|
| | | | IE type and | Semantics | | Assigned |
| IE/Group Name | Presence | Range | reference | description | Criticality | Criticality |

| | | | |
|---|---|---|---|
| >resource reservation | O | ENUMERATED | In case the SCG was |
| duration | | (sec15, sec30, | being suspended and |
| | | sec60, sec90, | lower layer SCG is being |
| | | sec120, sec180, | kept, this timer indicates |
| | | sec 360, sec | the amount of time the |
| | | 720, sec1440, | SN promises/expects to |
| | | long-time, . . .) | keep the SCG resources |
| | | | while the UE is in |
| | | | INACTIVE or has its |
| | | | SCG suspended. |
| | | | If “long-time” is included, |
| | | | the duration is expected |
| | | | to be longer than 1440 |
| | | | seconds. |

The specified duration (for which the SN intends to maintain the SCG resources) may be modified by the SN 806 after its initial transmission to the MN 804 in step 814. For example, an updated value of the duration may be indicated in further messages transmitted by the SN to the MN, such as a S-NODE MODIFICATION REQUIRED message (also known as SN Modification Required) or a NOTIFICATION CONTROL INDICATION message.

An example portion of the S-NODE MODIFICATION REQUIRED message is provided below (see in particular the Resource Reservation duration IE).

| IE/Group | | | IE type and | |
|---|---|---|---|---|
| Name | Presence | Range | reference | Semantics description |
| >resource | O | | ENUMERATED | In case the SCG was |
| reservation | | | (sec15, sec30, | suspended and lower layer |
| duration | | | sec60, sec90, | SCG is being kept, this timer |
| | | | sec120, sec180, | indicates the amount of time the |
| | | | sec 360, sec 720, | SN promises/expects to keep |
| | | | sec1440, long- | the SCG resources (after the |
| | | | time, . . .) | reception of this message) |
| | | | | while the UE is in INACTIVE or |
| | | | | has its SCG suspended. |
| | | | | If “long-time” is included, the |
| | | | | duration is expected to be |
| | | | | longer than 1440 seconds. |

An example portion of the NOTIFICATION CONTROL INDICATION message is provided below (see in particular the Resource Reservation duration IE).

| | | | | | | |
|---|---|---|---|---|---|---|
| | | | IE type and | Semantics | | Assigned |
| IE/Group Name | Presence | Range | reference | description | Criticality | Criticality |

| | | | |
|---|---|---|---|
| >resource | O | ENUMERATED | In case the SCG was |
| reservation | | (sec15, sec30, | suspended and lower layer |
| duration | | sec60, sec90, | SCG is being kept, this timer |
| | | sec120, sec180, | indicates the amount of time the |
| | | sec 360, sec 720, | SN promises/expects to keep |
| | | sec1440, long-time, | the SCG resources (after the |
| | | . . .) | reception of this message) |
| | | | while the UE is in INACTIVE or |
| | | | has its SCG suspended. |
| | | | If “long-time” is included, the |
| | | | duration is expected to be |
| | | | longer than 1440 seconds. |

The MN 804 may initiate a timer set to expire after the duration specified by the SN 806 in step 814 (or as modified thereafter). If the wireless device 802 is to be resumed from the INACTIVE state or the SCG is to be resumed before this timer expires (see step 822, for example), the MN 804 will know that it can resume the wireless device 802 with its suspended SCG configuration (and notwithstanding steps 818 and 820 described below); conversely, if the timer has expired, the MN 804 will indicate to the wireless device 802 in step 824 below to release the SCG configuration upon resuming the SCG for the UE or moving the UE to the CONNECTED state.

In step 816, the MN 804 uses RRC signalling to the wireless device 802 to instruct the wireless device 802 to enter the inactive mode. Thus, in the illustrated embodiment, the wireless device 802 is in the inactive mode and the SCG is suspended. However, the SN 806 has maintained an allocation of resources to the one or more layers as per step 812.

In step 818, the SN 806 transmits a third message to the MN 804. The third message may comprise an indication that the SN 806 is releasing resources associated with the one or more layers of a radio connection between the SN 806 and the wireless device 802. As noted above, the indication may equivalently indicate that the resources have been released or will be released. In the latter case, the third message may comprise an indication of a time at which the resources will be released.

The third message may be transmitted by the SN 806 upon a determination that the resources are required to service one or more other wireless devices seeking service from the SN 806. For example, the third message may be triggered based on the traffic flowing on the SN 806 (e.g., the number of connections or active connections, or the amount of data flowing through the SN 806). If the traffic exceeds a threshold, the third message may be triggered so that the SN 806 has sufficient available resources to serve other wireless devices.

The third message may comprise an SN Modification Required message (also known as S-NODE Modification Required). The indication may comprise an information element set to a particular value. For example, the I E may be a Lower Layer Presence Status Change IE. The particular value may be repurposed from pre-defined values for the IE (such as “release lower layers”), or a new value dedicated for the purpose of indicating that the SN 806 is releasing the resources.

In response to receipt of the third message, the MN 804 may transmit an acknowledgement message or similar to the SN 806 (not illustrated). However, particularly in embodiments where the wireless device is in inactive mode or the SCG is suspended, the MN 804 may refrain from taking any action to inform the wireless device 802 that the SN 806 is releasing the resources. In this way, should the SN 806 re-allocate resources to the one or more layers before the SCG is resumed or the wireless device 802 enters an active mode, no signalling is required to the wireless device 802.

Thus, as shown in step 820 of the illustrated embodiment, the SN 806 sends a fourth message to the MN 804. The fourth message may comprise an indication that the SN 806 is re-allocating resources to the one or more layers of the radio connection between the SN 806 and the wireless device 802. As noted above, the indication may equivalently indicate that the resources have been re-allocated or will be re-allocated. In the latter case, the fourth message may comprise an indication of a time at which the resources will be re-allocated.

The fourth message may comprise a further SN Modification Required message (also known as S-NODE Modification Required). The indication may comprise an information element set to a particular value. For example, the I E may be a Lower Layer Presence Status Change IE. The particular value may be repurposed from pre-defined values for the IE (such as “re-establish lower layers”), or a new value dedicated for the purpose of indicating that the SN 806 is re-allocating the resources.

In step 822, the MN 804 decides to send the wireless device 802 to an active mode (such as RRC_CONNECTED). For example, the wireless device 802 may have uplink data to transmit, or the network (either the MN 804 or the SN 806) may have downlink data to transmit. If the SN 806 has re-allocated resources to the one or more layers (e.g., as in step 820), then no further signalling needs to take place with respect to the secondary node connection; in step 824, the MN 804 utilizes RRC signalling to send the wireless device 802 to the active mode and to resume its connection with the SN 806 and/or the MN 804. However, if the SN 806 has not re-allocated resources to the one or more layers (e.g., step 820 did not take place, or the resources were re-released), step 824 may additionally comprise the MN 804 reconfiguring the wireless device 802 with an alternative secondary cell group.

Although the subject matter described herein may be implemented in any appropriate type of system using any suitable components, the embodiments disclosed herein are described in relation to a wireless network, such as the example wireless network illustrated in FIG. 9. For simplicity, the wireless network of FIG. 9 only depicts network 906, network nodes 960 and 960b, and WDs 910, 910b, and 910c. In practice, a wireless network may further include any additional elements suitable to support communication between wireless devices or between a wireless device and another communication device, such as a landline telephone, a service provider, or any other network node or end device. Of the illustrated components, network node 960 and wireless device (WD) 910 are depicted with additional detail. The wireless network may provide communication and other types of services to one or more wireless devices to facilitate the wireless devices' access to and/or use of the services provided by, or via, the wireless network.

According to embodiments of the disclosure, the wireless device 910 may be configured with connections to multiple network nodes 960 concurrently; so-called dual-connectivity or multi-connectivity. In such configurations, at least one of the network nodes 960 is known as a master node, providing control plane and optionally user plane connections to the network, and at least one of the network nodes 960 is known as a secondary node, providing user plane and optionally control plane connections to the network. The master node and the secondary node(s) may communicate with each other to co-ordinate their radio connections with the wireless device 910. For example, the master node and the secondary node(s) may communicate over a direct interface, such as the Xn interface.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 906 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 960 and WD 910 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 9, network node 960 includes processing circuitry 970, device readable medium 980, interface 990, auxiliary equipment 984, power source 986, power circuitry 987, and antenna 962. Although network node 960 illustrated in the example wireless network of FIG. 9 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 960 are depicted as single boxes located within a larger box, or nested within multiple boxes, in practice, a network node may comprise multiple different physical components that make up a single illustrated component (e.g., device readable medium 980 may comprise multiple separate hard drives as well as multiple RAM modules).

Similarly, network node 960 may be composed of multiple physically separate components (e.g., a NodeB component and a RNC component, or a BTS component and a BSC component, etc.), which may each have their own respective components. In certain scenarios in which network node 960 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 960 may be configured to support multiple radio access technologies (RATs). In such embodiments, some components may be duplicated (e.g., separate device readable medium 980 for the different RATs) and some components may be reused (e.g., the same antenna 962 may be shared by the RATs). Network node 960 may also include multiple sets of the various illustrated components for different wireless technologies integrated into network node 960, such as, for example, GSM, WCDMA, LTE, NR, WiFi, or Bluetooth wireless technologies. These wireless technologies may be integrated into the same or different chip or set of chips and other components within network node 960.

Processing circuitry 970 is configured to perform any determining, calculating, or similar operations (e.g., certain obtaining operations) described herein as being provided by a network node. These operations performed by processing circuitry 970 may include processing information obtained by processing circuitry 970 by, for example, converting the obtained information into other information, comparing the obtained information or converted information to information stored in the network node, and/or performing one or more operations based on the obtained information or converted information, and as a result of said processing making a determination.

Processing circuitry 970 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 960 components, such as device readable medium 980, network node 960 functionality. For example, processing circuitry 970 may execute instructions stored in device readable medium 980 or in memory within processing circuitry 970. Such functionality may include providing any of the various wireless features, functions, or benefits discussed herein. In some embodiments, processing circuitry 970 may include a system on a chip (SOC).

In some embodiments, processing circuitry 970 may include one or more of radio frequency (RF) transceiver circuitry 972 and baseband processing circuitry 974. In some embodiments, radio frequency (RF) transceiver circuitry 972 and baseband processing circuitry 974 may be on separate chips (or sets of chips), boards, or units, such as radio units and digital units. In alternative embodiments, part or all of RF transceiver circuitry 972 and baseband processing circuitry 974 may be on the same chip or set of chips, boards, or units

In certain embodiments, some or all of the functionality described herein as being provided by a network node, base station, eNB or other such network device may be performed by processing circuitry 970 executing instructions stored on device readable medium 980 or memory within processing circuitry 970. In alternative embodiments, some or all of the functionality may be provided by processing circuitry 970 without executing instructions stored on a separate or discrete device readable medium, such as in a hard-wired manner. In any of those embodiments, whether executing instructions stored on a device readable storage medium or not, processing circuitry 970 can be configured to perform the described functionality. The benefits provided by such functionality are not limited to processing circuitry 970 alone or to other components of network node 960, but are enjoyed by network node 960 as a whole, and/or by end users and the wireless network generally.

Device readable medium 980 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 970. Device readable medium 980 may store any suitable instructions, data or information, including a computer program, software, an application including one or more of logic, rules, code, tables, etc. and/or other instructions capable of being executed by processing circuitry 970 and, utilized by network node 960. Device readable medium 980 may be used to store any calculations made by processing circuitry 970 and/or any data received via interface 990. In some embodiments, processing circuitry 970 and device readable medium 980 may be considered to be integrated.

Interface 990 is used in the wired or wireless communication of signalling and/or data between network node 960, network 906, and/or WDs 910. As illustrated, interface 990 comprises port(s)/terminal(s) 994 to send and receive data, for example to and from network 906 over a wired connection. Interface 990 also includes radio front end circuitry 992 that may be coupled to, or in certain embodiments a part of, antenna 962. Radio front end circuitry 992 comprises filters 998 and amplifiers 996. Radio front end circuitry 992 may be connected to antenna 962 and processing circuitry 970. Radio front end circuitry may be configured to condition signals communicated between antenna 962 and processing circuitry 970. Radio front end circuitry 992 may receive digital data that is to be sent out to other network nodes or WDs via a wireless connection. Radio front end circuitry 992 may convert the digital data into a radio signal having the appropriate channel and bandwidth parameters using a combination of filters 998 and/or amplifiers 996. The radio signal may then be transmitted via antenna 962. Similarly, when receiving data, antenna 962 may collect radio signals which are then converted into digital data by radio front end circuitry 992. The digital data may be passed to processing circuitry 970. In other embodiments, the interface may comprise different components and/or different combinations of components.

In certain alternative embodiments, network node 960 may not include separate radio front end circuitry 992, instead, processing circuitry 970 may comprise radio front end circuitry and may be connected to antenna 962 without separate radio front end circuitry 992. Similarly, in some embodiments, all or some of RF transceiver circuitry 972 may be considered a part of interface 990. In still other embodiments, interface 990 may include one or more ports or terminals 994, radio front end circuitry 992, and RF transceiver circuitry 972, as part of a radio unit (not shown), and interface 990 may communicate with baseband processing circuitry 974, which is part of a digital unit (not shown).

Antenna 962 may include one or more antennas, or antenna arrays, configured to send and/or receive wireless signals. Antenna 962 may be coupled to radio front end circuitry 990 and may be any type of antenna capable of transmitting and receiving data and/or signals wirelessly. In some embodiments, antenna 962 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 962 may be separate from network node 960 and may be connectable to network node 960 through an interface or port.

Antenna 962, interface 990, and/or processing circuitry 970 may be configured to perform any receiving operations and/or certain obtaining operations described herein as being performed by a network node. Any information, data and/or signals may be received from a wireless device, another network node and/or any other network equipment. Similarly, antenna 962, interface 990, and/or processing circuitry 970 may be configured to perform any transmitting operations described herein as being performed by a network node. Any information, data and/or signals may be transmitted to a wireless device, another network node and/or any other network equipment.

Power circuitry 987 may comprise, or be coupled to, power management circuitry and is configured to supply the components of network node 960 with power for performing the functionality described herein. Power circuitry 987 may receive power from power source 986. Power source 986 and/or power circuitry 987 may be configured to provide power to the various components of network node 960 in a form suitable for the respective components (e.g., at a voltage and current level needed for each respective component). Power source 986 may either be included in, or external to, power circuitry 987 and/or network node 960. For example, network node 960 may be connectable to an external power source (e.g., an electricity outlet) via an input circuitry or interface such as an electrical cable, whereby the external power source supplies power to power circuitry 987. As a further example, power source 986 may comprise a source of power in the form of a battery or battery pack which is connected to, or integrated in, power circuitry 987. The battery may provide backup power should the external power source fail. Other types of power sources, such as photovoltaic devices, may also be used.

Alternative embodiments of network node 960 may include additional components beyond those shown in FIG. 9 that may be responsible for providing certain aspects of the network node's functionality, including any of the functionality described herein and/or any functionality necessary to support the subject matter described herein. For example, network node 960 may include user interface equipment to allow input of information into network node 960 and to allow output of information from network node 960. This may allow a user to perform diagnostic, maintenance, repair, and other administrative functions for network node 960.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V21), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 910 includes antenna 911, interface 914, processing circuitry 920, device readable medium 930, user interface equipment 932, auxiliary equipment 934, power source 936 and power circuitry 937. WD 910 may include multiple sets of one or more of the illustrated components for different wireless technologies supported by WD 910, such as, for example, GSM, WCDMA, LTE, NR, WiFi, WiMAX, or Bluetooth wireless technologies, just to mention a few. These wireless technologies may be integrated into the same or different chips or set of chips as other components within WD 910.

Antenna 911 may include one or more antennas or antenna arrays, configured to send and/or receive wireless signals, and is connected to interface 914. In certain alternative embodiments, antenna 911 may be separate from WD 910 and be connectable to WD 910 through an interface or port. Antenna 911, interface 914, and/or processing circuitry 920 may be configured to perform any receiving or transmitting operations described herein as being performed by a WD. Any information, data and/or signals may be received from a network node and/or another WD. In some embodiments, radio front end circuitry and/or antenna 911 may be considered an interface.

As illustrated, interface 914 comprises radio front end circuitry 912 and antenna 911. Radio front end circuitry 912 comprise one or more filters 918 and amplifiers 916. Radio front end circuitry 914 is connected to antenna 911 and processing circuitry 920, and is configured to condition signals communicated between antenna 911 and processing circuitry 920. Radio front end circuitry 912 may be coupled to or a part of antenna 911. In some embodiments, WD 910 may not include separate radio front end circuitry 912; rather, processing circuitry 920 may comprise radio front end circuitry and may be connected to antenna 911. Similarly, in some embodiments, some or all of RF transceiver circuitry 922 may be considered a part of interface 914. Radio front end circuitry 912 may receive digital data that is to be sent out to other network nodes or WDs via a wireless connection. Radio front end circuitry 912 may convert the digital data into a radio signal having the appropriate channel and bandwidth parameters using a combination of filters 918 and/or amplifiers 916. The radio signal may then be transmitted via antenna 911. Similarly, when receiving data, antenna 911 may collect radio signals which are then converted into digital data by radio front end circuitry 912. The digital data may be passed to processing circuitry 920. In other embodiments, the interface may comprise different components and/or different combinations of components.

Processing circuitry 920 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 910 components, such as device readable medium 930, WD 910 functionality. Such functionality may include providing any of the various wireless features or benefits discussed herein. For example, processing circuitry 920 may execute instructions stored in device readable medium 930 or in memory within processing circuitry 920 to provide the functionality disclosed herein.

As illustrated, processing circuitry 920 includes one or more of RF transceiver circuitry 922, baseband processing circuitry 924, and application processing circuitry 926. In other embodiments, the processing circuitry may comprise different components and/or different combinations of components. In certain embodiments processing circuitry 920 of WD 910 may comprise a SOC. In some embodiments, RF transceiver circuitry 922, baseband processing circuitry 924, and application processing circuitry 926 may be on separate chips or sets of chips. In alternative embodiments, part or all of baseband processing circuitry 924 and application processing circuitry 926 may be combined into one chip or set of chips, and RF transceiver circuitry 922 may be on a separate chip or set of chips. In still alternative embodiments, part or all of RF transceiver circuitry 922 and baseband processing circuitry 924 may be on the same chip or set of chips, and application processing circuitry 926 may be on a separate chip or set of chips. In yet other alternative embodiments, part or all of RF transceiver circuitry 922, baseband processing circuitry 924, and application processing circuitry 926 may be combined in the same chip or set of chips. In some embodiments, RF transceiver circuitry 922 may be a part of interface 914. RF transceiver circuitry 922 may condition RF signals for processing circuitry 920.

In certain embodiments, some or all of the functionality described herein as being performed by a WD may be provided by processing circuitry 920 executing instructions stored on device readable medium 930, which in certain embodiments may be a computer-readable storage medium. In alternative embodiments, some or all of the functionality may be provided by processing circuitry 920 without executing instructions stored on a separate or discrete device readable storage medium, such as in a hard-wired manner. In any of those particular embodiments, whether executing instructions stored on a device readable storage medium or not, processing circuitry 920 can be configured to perform the described functionality. The benefits provided by such functionality are not limited to processing circuitry 920 alone or to other components of WD 910, but are enjoyed by WD 910 as a whole, and/or by end users and the wireless network generally.

Processing circuitry 920 may be configured to perform any determining, calculating, or similar operations (e.g., certain obtaining operations) described herein as being performed by a WD. These operations, as performed by processing circuitry 920, may include processing information obtained by processing circuitry 920 by, for example, converting the obtained information into other information, comparing the obtained information or converted information to information stored by WD 910, and/or performing one or more operations based on the obtained information or converted information, and as a result of said processing making a determination.

Device readable medium 930 may be operable to store a computer program, software, an application including one or more of logic, rules, code, tables, etc. and/or other instructions capable of being executed by processing circuitry 920. Device readable medium 930 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 920. In some embodiments, processing circuitry 920 and device readable medium 930 may be considered to be integrated.

User interface equipment 932 may provide components that allow for a human user to interact with WD 910. Such interaction may be of many forms, such as visual, audial, tactile, etc. User interface equipment 932 may be operable to produce output to the user and to allow the user to provide input to WD 910. The type of interaction may vary depending on the type of user interface equipment 932 installed in WD 910. For example, if WD 910 is a smart phone, the interaction may be via a touch screen; if WD 910 is a smart meter, the interaction may be through a screen that provides usage (e.g., the number of gallons used) or a speaker that provides an audible alert (e.g., if smoke is detected). User interface equipment 932 may include input interfaces, devices and circuits, and output interfaces, devices and circuits. User interface equipment 932 is configured to allow input of information into WD 910, and is connected to processing circuitry 920 to allow processing circuitry 920 to process the input information. User interface equipment 932 may include, for example, a microphone, a proximity or other sensor, keys/buttons, a touch display, one or more cameras, a USB port, or other input circuitry. User interface equipment 932 is also configured to allow output of information from WD 910, and to allow processing circuitry 920 to output information from WD 910. User interface equipment 932 may include, for example, a speaker, a display, vibrating circuitry, a USB port, a headphone interface, or other output circuitry. Using one or more input and output interfaces, devices, and circuits, of user interface equipment 932, WD 910 may communicate with end users and/or the wireless network, and allow them to benefit from the functionality described herein.

Auxiliary equipment 934 is operable to provide more specific functionality which may not be generally performed by WDs. This may comprise specialized sensors for doing measurements for various purposes, interfaces for additional types of communication such as wired communications etc. The inclusion and type of components of auxiliary equipment 934 may vary depending on the embodiment and/or scenario.

Power source 936 may, in some embodiments, be in the form of a battery or battery pack. Other types of power sources, such as an external power source (e.g., an electricity outlet), photovoltaic devices or power cells, may also be used. WD 910 may further comprise power circuitry 937 for delivering power from power source 936 to the various parts of WD 910 which need power from power source 936 to carry out any functionality described or indicated herein. Power circuitry 937 may in certain embodiments comprise power management circuitry. Power circuitry 937 may additionally or alternatively be operable to receive power from an external power source; in which case WD 910 may be connectable to the external power source (such as an electricity outlet) via input circuitry or an interface such as an electrical power cable. Power circuitry 937 may also in certain embodiments be operable to deliver power from an external power source to power source 936. This may be, for example, for the charging of power source 936. Power circuitry 937 may perform any formatting, converting, or other modification to the power from power source 936 to make the power suitable for the respective components of WD 910 to which power is supplied.

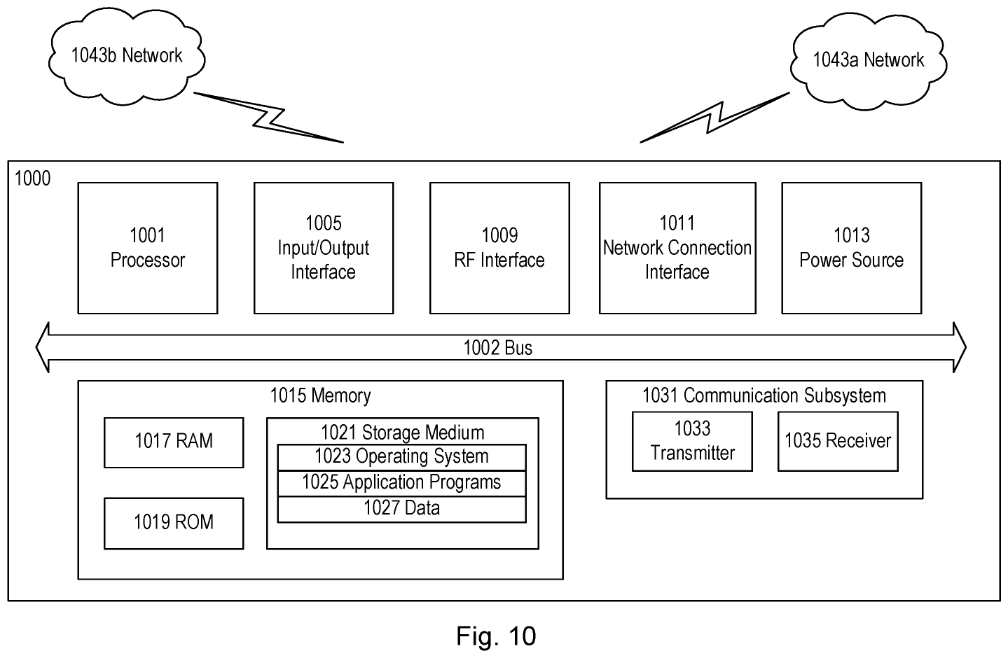

FIG. 10 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1000 may be any UE identified by the 3^{rd} Generation Partnership Project (3GPP), including a NB-IoT UE, a machine type communication (MTC) UE, and/or an enhanced MTC (eMTC) UE. UE 1000, as illustrated in FIG. 10, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 10 is a UE, the components discussed herein are equally applicable to a WD, and vice-versa.

In FIG. 10, UE 1000 includes processing circuitry 1001 that is operatively coupled to input/output interface 1005, radio frequency (RF) interface 1009, network connection interface 1011, memory 1015 including random access memory (RAM) 1017, read-only memory (ROM) 1019, and storage medium 1021 or the like, communication subsystem 1031, power source 1033, and/or any other component, or any combination thereof. Storage medium 1021 includes operating system 1023, application program 1025, and data 1027. In other embodiments, storage medium 1021 may include other similar types of information. Certain UEs may utilize all of the components shown in FIG. 10, or only a subset of the components. The level of integration between the components may vary from one UE to another UE. Further, certain UEs may contain multiple instances of a component, such as multiple processors, memories, transceivers, transmitters, receivers, etc.

In FIG. 10, processing circuitry 1001 may be configured to process computer instructions and data. Processing circuitry 1001 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1001 may include two central processing units (CPUs). Data may be information in a form suitable for use by a computer.

In the depicted embodiment, input/output interface 1005 may be configured to provide a communication interface to an input device, output device, or input and output device. UE 1000 may be configured to use an output device via input/output interface 1005. An output device may use the same type of interface port as an input device. For example, a USB port may be used to provide input to and output from UE 1000. The output device may be a speaker, a sound card, a video card, a display, a monitor, a printer, an actuator, an emitter, a smartcard, another output device, or any combination thereof. UE 1000 may be configured to use an input device via input/output interface 1005 to allow a user to capture information into UE 1000. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 10, RF interface 1009 may be configured to provide a communication interface to RF components such as a transmitter, a receiver, and an antenna. Network connection interface 1011 may be configured to provide a communication interface to network 1043a. Network 1043a may encompass wired and/or wireless networks such as a local-area network (LAN), a wide-area network (WAN), a computer network, a wireless network, a telecommunications network, another like network or any combination thereof. For example, network 1043a may comprise a Wi-Fi network. Network connection interface 1011 may be configured to include a receiver and a transmitter interface used to communicate with one or more other devices over a communication network according to one or more communication protocols, such as Ethernet, TCP/IP, SONET, ATM, or the like. Network connection interface 1011 may implement receiver and transmitter functionality appropriate to the communication network links (e.g., optical, electrical, and the like). The transmitter and receiver functions may share circuit components, software or firmware, or alternatively may be implemented separately.

RAM 1017 may be configured to interface via bus 1002 to processing circuitry 1001 to provide storage or caching of data or computer instructions during the execution of software programs such as the operating system, application programs, and device drivers. ROM 1019 may be configured to provide computer instructions or data to processing circuitry 1001. For example, ROM 1019 may be configured to store invariant low-level system code or data for basic system functions such as basic input and output (I/O), startup, or reception of keystrokes from a keyboard that are stored in a non-volatile memory. Storage medium 1021 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1021 may be configured to include operating system 1023, application program 1025 such as a web browser application, a widget or gadget engine or another application, and data file 1027. Storage medium 1021 may store, for use by UE 1000, any of a variety of various operating systems or combinations of operating systems.

Storage medium 1021 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1021 may allow UE 1000 to access computer-executable instructions, application programs or the like, stored on transitory or non-transitory memory media, to off-load data, or to upload data. An article of manufacture, such as one utilizing a communication system may be tangibly embodied in storage medium 1021, which may comprise a device readable medium.

In FIG. 10, processing circuitry 1001 may be configured to communicate with network 1043b using communication subsystem 1031. Network 1043a and network 1043b may be the same network or networks or different network or networks. Communication subsystem 1031 may be configured to include one or more transceivers used to communicate with network 1043b. For example, communication subsystem 1031 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1033 and/or receiver 1035 to implement transmitter or receiver functionality, respectively, appropriate to the RAN links (e.g., frequency allocations and the like). Further, transmitter 1033 and receiver 1035 of each transceiver may share circuit components, software or firmware, or alternatively may be implemented separately.

In the illustrated embodiment, the communication functions of communication subsystem 1031 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1031 may include cellular communication, Wi-Fi communication, Bluetooth communication, and GPS communication. Network 1043b may encompass wired and/or wireless networks such as a local-area network (LAN), a wide-area network (WAN), a computer network, a wireless network, a telecommunications network, another like network or any combination thereof. For example, network 1043b may be a cellular network, a Wi-Fi network, and/or a near-field network. Power source 1013 may be configured to provide alternating current (AC) or direct current (DC) power to components of UE 1000.

The features, benefits and/or functions described herein may be implemented in one of the components of UE 1000 or partitioned across multiple components of UE 1000. Further, the features, benefits, and/or functions described herein may be implemented in any combination of hardware, software or firmware. In one example, communication subsystem 1031 may be configured to include any of the components described herein. Further, processing circuitry 1001 may be configured to communicate with any of such components over bus 1002. In another example, any of such components may be represented by program instructions stored in memory that when executed by processing circuitry 1001 perform the corresponding functions described herein. In another example, the functionality of any of such components may be partitioned between processing circuitry 1001 and communication subsystem 1031. In another example, the non-computationally intensive functions of any of such components may be implemented in software or firmware and the computationally intensive functions may be implemented in hardware.

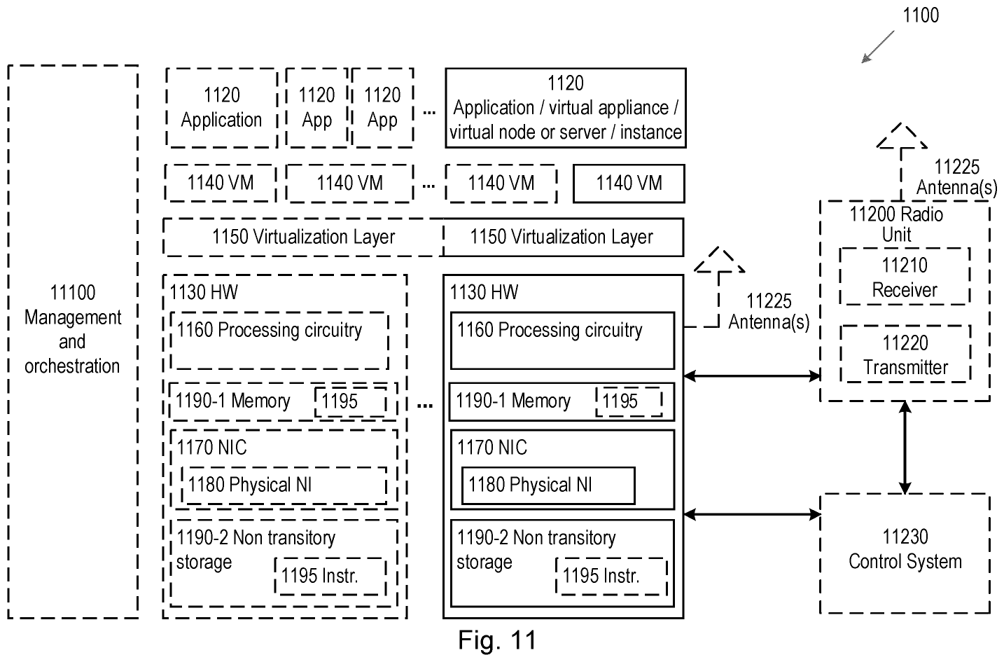

FIG. 11 is a schematic block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1100 hosted by one or more of hardware nodes 1130. Further, in embodiments in which the virtual node is not a radio access node or does not require radio connectivity (e.g., a core network node), then the network node may be entirely virtualized.

The functions may be implemented by one or more applications 1120 (which may alternatively be called software instances, virtual appliances, network functions, virtual nodes, virtual network functions, etc.) operative to implement some of the features, functions, and/or benefits of some of the embodiments disclosed herein. Applications 1120 are run in virtualization environment 1100 which provides hardware 1130 comprising processing circuitry 1160 and memory 1190. Memory 1190 contains instructions 1195 executable by processing circuitry 1160 whereby application 1120 is operative to provide one or more of the features, benefits, and/or functions disclosed herein.

Virtualization environment 1100, comprises general-purpose or special-purpose network hardware devices 1130 comprising a set of one or more processors or processing circuitry 1160, which may be commercial off-the-shelf (COTS) processors, dedicated Application Specific Integrated Circuits (ASICs), or any other type of processing circuitry including digital or analog hardware components or special purpose processors. Each hardware device may comprise memory 1190-1 which may be non-persistent memory for temporarily storing instructions 1195 or software executed by processing circuitry 1160. Each hardware device may comprise one or more network interface controllers (NICs) 1170, also known as network interface cards, which include physical network interface 1180. Each hardware device may also include non-transitory, persistent, machine-readable storage media 1190-2 having stored therein software 1195 and/or instructions executable by processing circuitry 1160. Software 1195 may include any type of software including software for instantiating one or more virtualization layers 1150 (also referred to as hypervisors), software to execute virtual machines 1140 as well as software allowing it to execute functions, features and/or benefits described in relation with some embodiments described herein.

Virtual machines 1140, comprise virtual processing, virtual memory, virtual networking or interface and virtual storage, and may be run by a corresponding virtualization layer 1150 or hypervisor. Different embodiments of the instance of virtual appliance 1120 may be implemented on one or more of virtual machines 1140, and the implementations may be made in different ways.

During operation, processing circuitry 1160 executes software 1195 to instantiate the hypervisor or virtualization layer 1150, which may sometimes be referred to as a virtual machine monitor (VMM). Virtualization layer 1150 may present a virtual operating platform that appears like networking hardware to virtual machine 1140.

As shown in FIG. 11, hardware 1130 may be a standalone network node with generic or specific components. Hardware 1130 may comprise antenna 11225 and may implement some functions via virtualization. Alternatively, hardware 1130 may be part of a larger cluster of hardware (e.g. such as in a data center or customer premise equipment (CPE)) where many hardware nodes work together and are managed via management and orchestration (MANO) 11100, which, among others, oversees lifecycle management of applications 1120.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1140 may be a software implementation of a physical machine that runs programs as if they were executing on a physical, non-virtualized machine. Each of virtual machines 1140, and that part of hardware 1130 that executes that virtual machine, be it hardware dedicated to that virtual machine and/or hardware shared by that virtual machine with others of the virtual machines 1140, forms a separate virtual network elements (VNE).

Still in the context of NFV, Virtual Network Function (VNF) is responsible for handling specific network functions that run in one or more virtual machines 1140 on top of hardware networking infrastructure 1130 and corresponds to application 1120 in FIG. 11.

In some embodiments, one or more radio units 11200 that each include one or more transmitters 11220 and one or more receivers 11210 may be coupled to one or more antennas 11225. Radio units 11200 may communicate directly with hardware nodes 1130 via one or more appropriate network interfaces and may be used in combination with the virtual components to provide a virtual node with radio capabilities, such as a radio access node or a base station.

In some embodiments, some signalling can be effected with the use of control system 11230 which may alternatively be used for communication between the hardware nodes 1130 and radio units 11200.

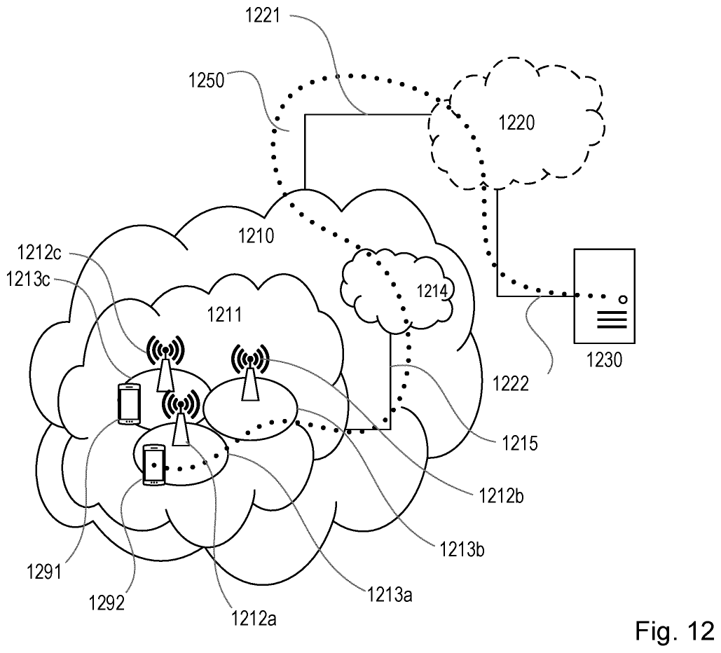

With reference to FIG. 12, in accordance with an embodiment, a communication system includes telecommunication network 1210, such as a 3GPP-type cellular network, which comprises access network 1211, such as a radio access network, and core network 1214. Access network 1211 comprises a plurality of base stations 1212a, 1212b, 1212c, such as NBs, eNBs, gNBs or other types of wireless access points, each defining a corresponding coverage area 1213a, 1213b, 1213c. Each base station 1212a, 1212b, 1212c is connectable to core network 1214 over a wired or wireless connection 1215. A first UE 1291 located in coverage area 1213c is configured to wirelessly connect to, or be paged by, the corresponding base station 1212c. A second UE 1292 in coverage area 1213a is wirelessly connectable to the corresponding base station 1212a. While a plurality of UEs 1291, 1292 are illustrated in this example, the disclosed embodiments are equally applicable to a situation where a sole UE is in the coverage area or where a sole UE is connecting to the corresponding base station 1212.

Telecommunication network 1210 is itself connected to host computer 1230, which may be embodied in the hardware and/or software of a standalone server, a cloud-implemented server, a distributed server or as processing resources in a server farm. Host computer 1230 may be under the ownership or control of a service provider, or may be operated by the service provider or on behalf of the service provider. Connections 1221 and 1222 between telecommunication network 1210 and host computer 1230 may extend directly from core network 1214 to host computer 1230 or may go via an optional intermediate network 1220. Intermediate network 1220 may be one of, or a combination of more than one of, a public, private or hosted network; intermediate network 1220, if any, may be a backbone network or the Internet; in particular, intermediate network 1220 may comprise two or more sub-networks (not shown).

The communication system of FIG. 12 as a whole enables connectivity between the connected UEs 1291, 1292 and host computer 1230. The connectivity may be described as an over-the-top (OTT) connection 1250. Host computer 1230 and the connected UEs 1291, 1292 are configured to communicate data and/or signaling via OTT connection 1250, using access network 1211, core network 1214, any intermediate network 1220 and possible further infrastructure (not shown) as intermediaries. OTT connection 1250 may be transparent in the sense that the participating communication devices through which OTT connection 1250 passes are unaware of routing of uplink and downlink communications. For example, base station 1212 may not or need not be informed about the past routing of an incoming downlink communication with data originating from host computer 1230 to be forwarded (e.g., handed over) to a connected UE 1291. Similarly, base station 1212 need not be aware of the future routing of an outgoing uplink communication originating from the UE 1291 towards the host computer 1230.

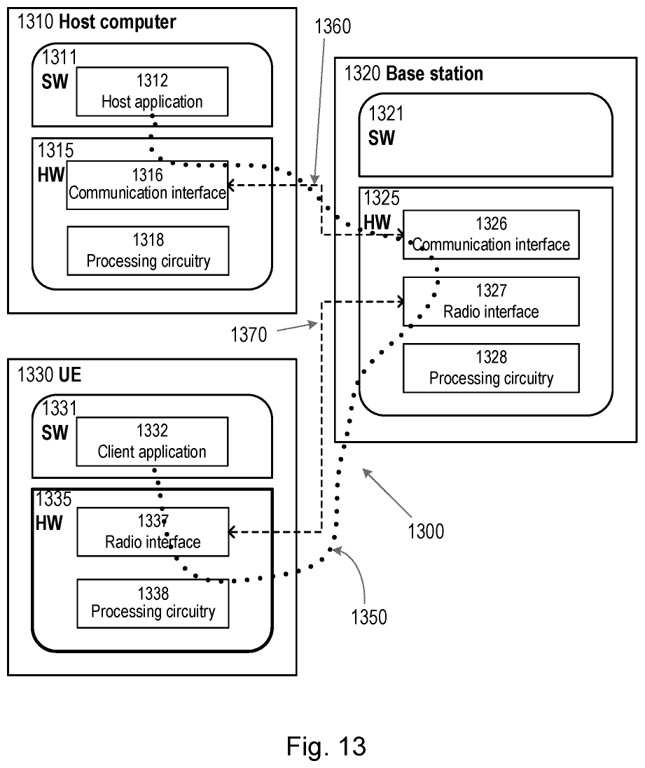

Example implementations, in accordance with an embodiment, of the UE, base station and host computer discussed in the preceding paragraphs will now be described with reference to FIG. 13. In communication system 1300, host computer 1310 comprises hardware 1315 including communication interface 1316 configured to set up and maintain a wired or wireless connection with an interface of a different communication device of communication system 1300. Host computer 1310 further comprises processing circuitry 1318, which may have storage and/or processing capabilities. In particular, processing circuitry 1318 may comprise one or more programmable processors, application-specific integrated circuits, field programmable gate arrays or combinations of these (not shown) adapted to execute instructions. Host computer 1310 further comprises software 1311, which is stored in or accessible by host computer 1310 and executable by processing circuitry 1318. Software 1311 includes host application 1312. Host application 1312 may be operable to provide a service to a remote user, such as UE 1330 connecting via OTT connection 1350 terminating at UE 1330 and host computer 1310. In providing the service to the remote user, host application 1312 may provide user data which is transmitted using OTT connection 1350.

Communication system 1300 further includes base station 1320 provided in a telecommunication system and comprising hardware 1325 enabling it to communicate with host computer 1310 and with UE 1330. Hardware 1325 may include communication interface 1326 for setting up and maintaining a wired or wireless connection with an interface of a different communication device of communication system 1300, as well as radio interface 1327 for setting up and maintaining at least wireless connection 1370 with UE 1330 located in a coverage area (not shown in FIG. 13) served by base station 1320. Communication interface 1326 may be configured to facilitate connection 1360 to host computer 1310. Connection 1360 may be direct or it may pass through a core network (not shown in FIG. 13) of the telecommunication system and/or through one or more intermediate networks outside the telecommunication system. In the embodiment shown, hardware 1325 of base station 1320 further includes processing circuitry 1328, which may comprise one or more programmable processors, application-specific integrated circuits, field programmable gate arrays or combinations of these (not shown) adapted to execute instructions. Base station 1320 further has software 1321 stored internally or accessible via an external connection.

Communication system 1300 further includes UE 1330 already referred to. Its hardware 1335 may include radio interface 1337 configured to set up and maintain wireless connection 1370 with a base station serving a coverage area in which UE 1330 is currently located. Hardware 1335 of UE 1330 further includes processing circuitry 1338, which may comprise one or more programmable processors, application-specific integrated circuits, field programmable gate arrays or combinations of these (not shown) adapted to execute instructions. UE 1330 further comprises software 1331, which is stored in or accessible by UE 1330 and executable by processing circuitry 1338. Software 1331 includes client application 1332. Client application 1332 may be operable to provide a service to a human or non-human user via UE 1330, with the support of host computer 1310. In host computer 1310, an executing host application 1312 may communicate with the executing client application 1332 via OTT connection 1350 terminating at UE 1330 and host computer 1310. In providing the service to the user, client application 1332 may receive request data from host application 1312 and provide user data in response to the request data. OTT connection 1350 may transfer both the request data and the user data. Client application 1332 may interact with the user to generate the user data that it provides.

It is noted that host computer 1310, base station 1320 and UE 1330 illustrated in FIG. 13 may be similar or identical to host computer 1230, one of base stations 1212a, 1212b, 1212c and one of UEs 1291, 1292 of FIG. 12, respectively. This is to say, the inner workings of these entities may be as shown in FIG. 13 and independently, the surrounding network topology may be that of FIG. 12.

In FIG. 13, OTT connection 1350 has been drawn abstractly to illustrate the communication between host computer 1310 and UE 1330 via base station 1320, without explicit reference to any intermediary devices and the precise routing of messages via these devices. Network infrastructure may determine the routing, which it may be configured to hide from UE 1330 or from the service provider operating host computer 1310, or both. While OTT connection 1350 is active, the network infrastructure may further take decisions by which it dynamically changes the routing (e.g., on the basis of load balancing consideration or reconfiguration of the network).

Wireless connection 1370 between UE 1330 and base station 1320 is in accordance with the teachings of the embodiments described throughout this disclosure. One or more of the various embodiments improve the performance of OTT services provided to UE 1330 using OTT connection 1350, in which wireless connection 1370 forms the last segment. More precisely, the teachings of these embodiments may improve the power consumption of the wireless device and thereby provide benefits such as extended battery lifetime.

A measurement procedure may be provided for the purpose of monitoring data rate, latency and other factors on which the one or more embodiments improve. There may further be an optional network functionality for reconfiguring OTT connection 1350 between host computer 1310 and UE 1330, in response to variations in the measurement results. The measurement procedure and/or the network functionality for reconfiguring OTT connection 1350 may be implemented in software 1311 and hardware 1315 of host computer 1310 or in software 1331 and hardware 1335 of UE 1330, or both. In embodiments, sensors (not shown) may be deployed in or in association with communication devices through which OTT connection 1350 passes; the sensors may participate in the measurement procedure by supplying values of the monitored quantities exemplified above, or supplying values of other physical quantities from which software 1311, 1331 may compute or estimate the monitored quantities. The reconfiguring of OTT connection 1350 may include message format, retransmission settings, preferred routing etc.; the reconfiguring need not affect base station 1320, and it may be unknown or imperceptible to base station 1320. Such procedures and functionalities may be known and practiced in the art. In certain embodiments, measurements may involve proprietary UE signaling facilitating host computer 1310's measurements of throughput, propagation times, latency and the like. The measurements may be implemented in that software 1311 and 1331 causes messages to be transmitted, in particular empty or ‘dummy’ messages, using OTT connection 1350 while it monitors propagation times, errors etc.

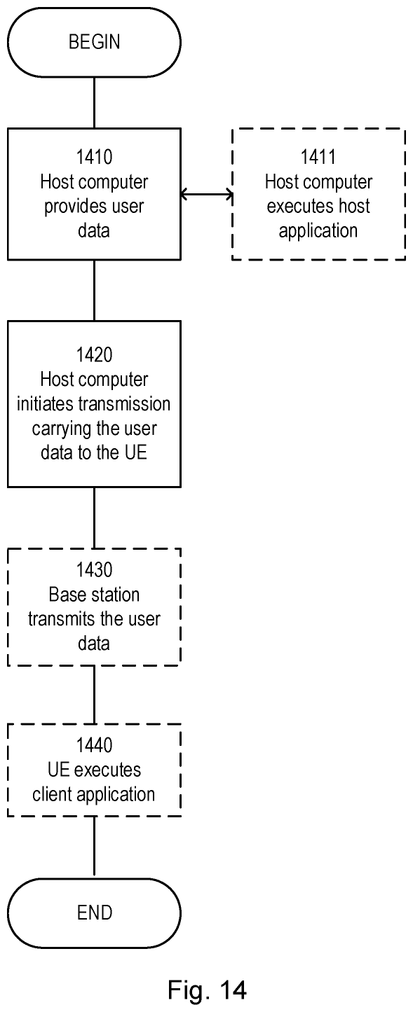

FIG. 14 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 14 will be included in this section. In step 1410, the host computer provides user data. In substep 1411 (which may be optional) of step 1410, the host computer provides the user data by executing a host application. In step 1420, the host computer initiates a transmission carrying the user data to the UE. In step 1430 (which may be optional), the base station transmits to the UE the user data which was carried in the transmission that the host computer initiated, in accordance with the teachings of the embodiments described throughout this disclosure. In step 1440 (which may also be optional), the UE executes a client application associated with the host application executed by the host computer.

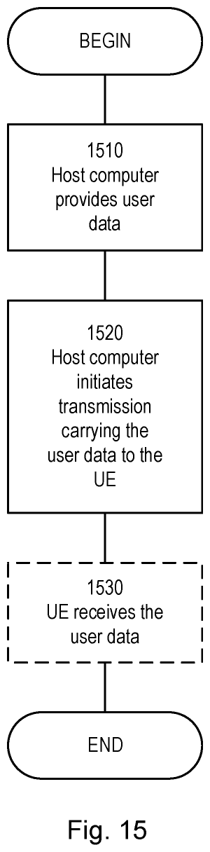

FIG. 15 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 15 will be included in this section. In step 1510 of the method, the host computer provides user data. In an optional substep (not shown) the host computer provides the user data by executing a host application. In step 1520, the host computer initiates a transmission carrying the user data to the UE. The transmission may pass via the base station, in accordance with the teachings of the embodiments described throughout this disclosure. In step 1530 (which may be optional), the UE receives the user data carried in the transmission.

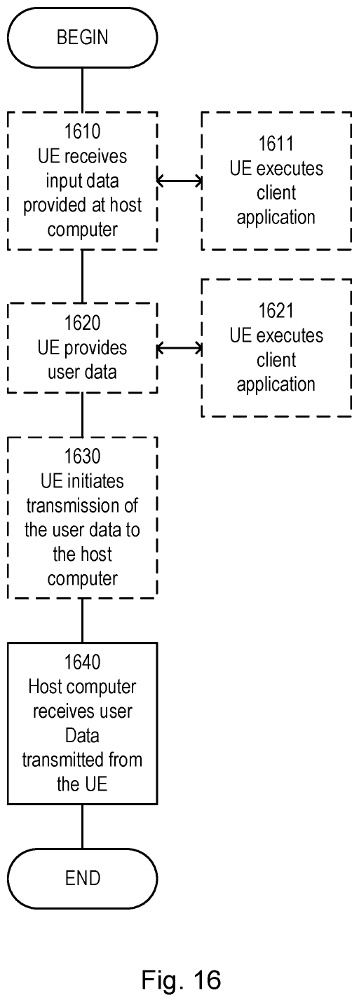

FIG. 16 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 16 will be included in this section. In step 1610 (which may be optional), the UE receives input data provided by the host computer. Additionally or alternatively, in step 1620, the UE provides user data. In substep 1621 (which may be optional) of step 1620, the UE provides the user data by executing a client application. In substep 1611 (which may be optional) of step 1610, the UE executes a client application which provides the user data in reaction to the received input data provided by the host computer. In providing the user data, the executed client application may further consider user input received from the user. Regardless of the specific manner in which the user data was provided, the UE initiates, in substep 1630 (which may be optional), transmission of the user data to the host computer. In step 1640 of the method, the host computer receives the user data transmitted from the UE, in accordance with the teachings of the embodiments described throughout this disclosure.

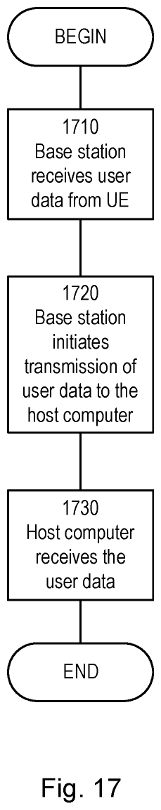

FIG. 17 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 17 will be included in this section. In step 1710 (which may be optional), in accordance with the teachings of the embodiments described throughout this disclosure, the base station receives user data from the UE. In step 1720 (which may be optional), the base station initiates transmission of the received user data to the host computer. In step 1730 (which may be optional), the host computer receives the user data carried in the transmission initiated by the base station.

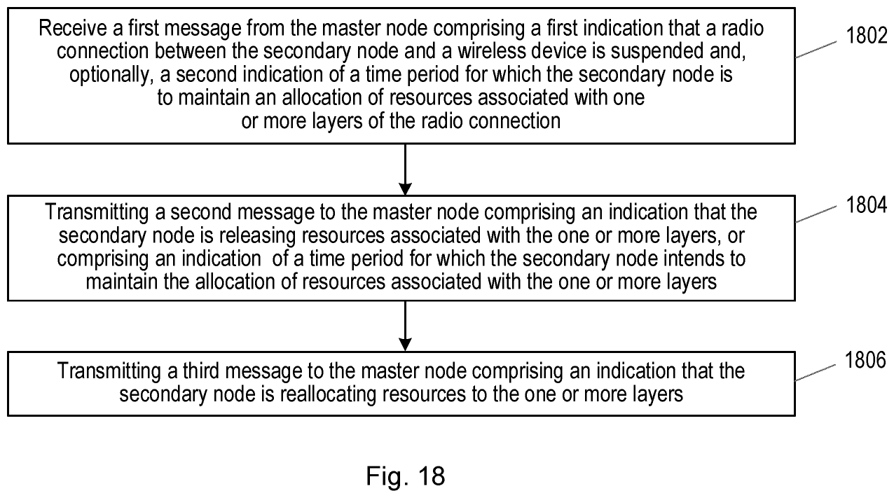

FIG. 18 depicts a method in accordance with particular embodiments. The method may be performed by a network node, such as a network node 960 described with respect to FIG. 9. The network node may be a base station configured as a secondary node for a wireless device having a dual- or multi-connectivity connection to a wireless communication network (such as the SN 806 described above with respect to FIG. 8). Thus the wireless device is configured with a master node and the network node performing the method (and potentially one or more further secondary nodes).

The method begins at step 1802, in which the secondary node receives a first message from the master node. Step 1802 may correspond to step 812 described above.

The first message may be transmitted via a direct interface, such as the Xn interface (and all messages described herein as being transmitted between the MN and the SN may be so transmitted). The first message may comprise an SN Modification Request message (also known as an S-NODE Modification Request message). The first message may comprise a first indication that a radio connection between the secondary node and the wireless device is suspended (or is to be suspended). Optionally, as per the second aspect described above, the first message may also comprise a second indication of a time period for which the secondary node is to maintain an allocation of resources associated with one or more layers of the radio connection between the secondary node and the wireless device despite the suspension of that radio connection. The one or more layers may comprise only a subset of the layers of the radio connection, such as an integer number of the lowest or lower layers, or an integer number of the highest or higher layers. The lower layers may comprise one or more of: a radio link control, RLC, layer; a medium access control, MAC, layer; and a physical, PHY, layer. The higher layers may comprise one or more of: a packet data convergence protocol, PDCP, layer; and a service data adaptation protocol, SDAP, layer.

The first indication may comprise a Lower Layer presence status change IE, set to a particular value indicating to suspend the SCG but to keep resources allocated for the one or more layers (such as the lower layers). The second indication may comprise an inactivity duration IE, set to one of a plurality of possible values, each defining a different duration of time for which the secondary node is expected to maintain resources for the one or more layers.

In step 1804, the SN transmits a second message to the master node. Step 1804 may correspond to step 814 and/or step 818 set out above.

In one embodiment, the second message may comprise an SN Modification Request Acknowledgement message (also known as an S-NODE Modification Request Acknowledgement message). Particularly where the first message comprises the second indication set out above, the second message may comprise an indication of a time period for which the secondary node intends to maintain the allocation of resources associated with one or more layers of the radio connection between the secondary node and the wireless device. The indication in the second message may comprise a Resource reservation duration IE. The indication may comprise the actual value of the time period, or one of a plurality of an index values which is interpreted by the master node as corresponding to a particular time period (e.g., through pre-configuration).

In an alternative embodiment, the second message may comprise an indication that the secondary node is releasing resources associated with the one or more layers of a radio connection between the secondary node and the wireless device. The indication may equivalently indicate that the resources have been released or will be released. In the latter case, the second message may comprise an indication of a time at which the resources will be released.

The second message may be transmitted by the secondary node upon a determination that the resources are required to service one or more other wireless devices seeking service from the secondary node. For example, the second message may be triggered based on the traffic flowing on the secondary node (e.g., the number of connections or active connections, or the amount of data flowing through the secondary node). If the traffic exceeds a threshold, the second message may be triggered so that the secondary node has sufficient available resources to serve other wireless devices.

The second message may comprise an SN Modification Required message (also known as S-NODE Modification Required). The indication may comprise an information element set to a particular value. For example, the IE may be a Lower Layer Presence Status Change IE. The particular value may be repurposed from pre-defined values for the IE (such as “release lower layers”), or a new value dedicated for the purpose of indicating that the secondary node is releasing the resources.

In step 1806, the secondary node sends a third message to the master node. Step 1806 may correspond to step 820 described above.

The third message comprises an indication that the secondary node is re-allocating resources to the one or more layers of the radio connection between the secondary node and the wireless device. The indication may equivalently indicate that the resources have been re-allocated or will be re-allocated. In the latter case, the third message may comprise an indication of a time at which the resources will be re-allocated.

The third message may comprise a further SN Modification Required message (also known as S-NODE Modification Required). The indication may comprise an information element set to a particular value. For example, the I E may be a Lower Layer Presence Status Change IE. The particular value may be repurposed from pre-defined values for the IE (such as “re-establish lower layers”), or a new value dedicated for the purpose of indicating that the secondary node is re-allocating the resources.

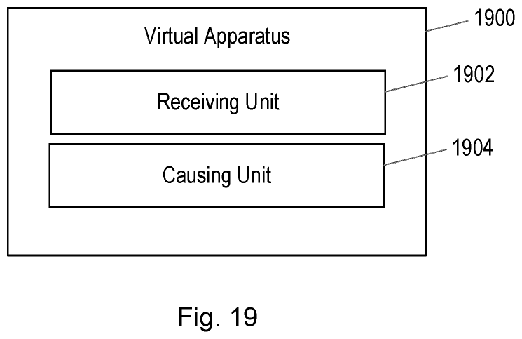

FIG. 19 illustrates a schematic block diagram of an apparatus 1900 in a wireless network (for example, the wireless network shown in FIG. 9). The apparatus may be implemented in a network node (e.g., network node 960 shown in FIG. 9, and/or the secondary node 806 shown in FIG. 8). Apparatus 1900 is operable to carry out the example method described with reference to FIG. 18 and possibly any other processes or methods disclosed herein. It is also to be understood that the method of FIG. 18 is not necessarily carried out solely by apparatus 1900. At least some operations of the method can be performed by one or more other entities.

Virtual Apparatus 1900 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving unit 1902 and causing unit 1904, and any other suitable units of apparatus 1900 to perform corresponding functions according one or more embodiments of the present disclosure.

As illustrated in FIG. 19, apparatus 1900 includes receiving unit 1902 and causing unit 1904. In one embodiment, receiving unit 1902 is configured to receive, from the master node, a message comprising a first indication that a radio connection between the base station and the wireless device is suspended, and a second indication of a time period for which the base station is to maintain an allocation of resources associated with one or more layers of the radio connection between the base station and the wireless device despite the suspension of that radio connection.

Additionally or alternatively, causing unit 1904 is configured to cause transmission of a message to the master node. The message comprises an indication that the base station is releasing resources associated with one or more layers of a radio connection between the base station and the wireless device.

The one or more layers may comprise a subset of the total layers of the radio connection between the secondary node and the wireless device, such as an integer number of lowest layers.

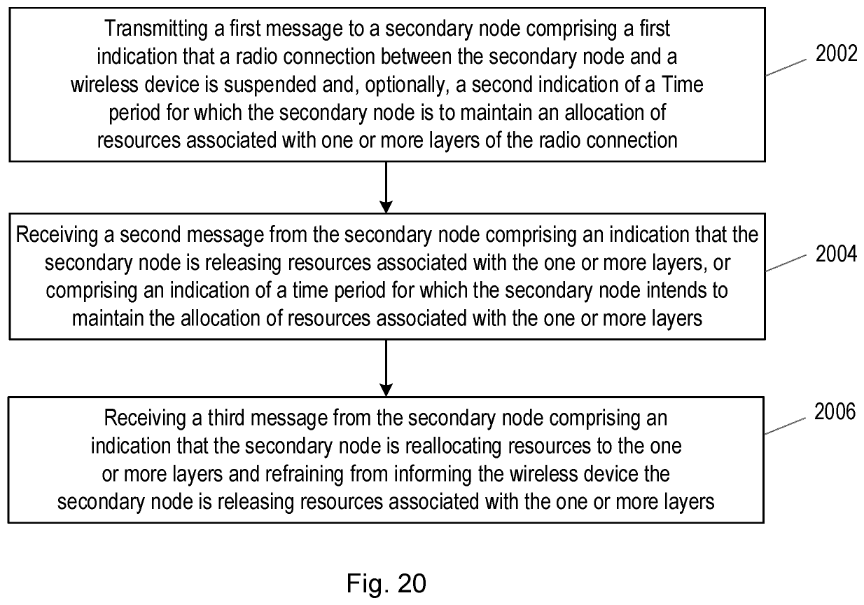

FIG. 20 depicts a method in accordance with particular embodiments. The method may be performed by a network node, such as a network node 960 described with respect to FIG. 9. The network node may be a base station configured as a master node for a wireless device having a dual- or multi-connectivity connection to a wireless communication network (such as the master node 804 shown in FIG. 8). Thus the wireless device is configured with the master node performing the method, and one or more secondary nodes.

The method begins at step 2002, in which the master node transmits a first message to the secondary node. Step 2002 may correspond to step 812 described above.

The first message may be transmitted via a direct interface, such as the Xn interface (and all messages described herein as being transmitted between the MN and the SN may be so transmitted). The first message may comprise an SN Modification Request message (also known as an S-NODE Modification Request message). The first message may comprise a first indication that a radio connection between the secondary node and the wireless device is suspended (or is to be suspended). Optionally, as per the second aspect described above, the first message may also comprise a second indication of a time period for which the secondary node is to maintain an allocation of resources associated with one or more layers of the radio connection between the secondary node and the wireless device despite the suspension of that radio connection. The one or more layers may comprise only a subset of the layers of the radio connection, such as an integer number of the lowest or lower layers, or an integer number of the highest or higher layers. The lower layers may comprise one or more of: a radio link control, RLC, layer; a medium access control, MAC, layer; and a physical, PHY, layer. The higher layers may comprise one or more of: a packet data convergence protocol, PDCP, layer; and a service data adaptation protocol, SDAP, layer.

The first indication may comprise a Lower Layer presence status change IE, set to a particular value indicating to suspend the SCG but to keep resources allocated for the one or more layers (such as the lower layers). The second indication may comprise an inactivity duration IE, set to one of a plurality of possible values, each defining a different duration of time for which the secondary node is expected to maintain resources for the one or more layers.

In step 2004, the master node receives a second message from the secondary node. Step 2004 may correspond to step 814 and/or step 818 set out above.

In one embodiment, the second message may comprise an SN Modification Request Acknowledgement message (also known as an S-NODE Modification Request Acknowledgement message). Particularly where the first message comprises the second indication set out above, the second message may comprise an indication of a time period for which the secondary node intends to maintain the allocation of resources associated with one or more layers of the radio connection between the secondary node and the wireless device. The indication in the second message may comprise a Resource reservation duration IE. The indication may comprise the actual value of the time period, or one of a plurality of an index values which is interpreted by the master node as corresponding to a particular time period (e.g., through pre-configuration).

The master node may initiate a timer set to expire after the duration indicated in the second message (or as modified thereafter). If the wireless device is to be resumed from the INACTIVE state or the SCG is to be resumed before this timer expires, the master node knows that it can resume the wireless device with its suspended SCG configuration (and notwithstanding step 2006 described below); conversely, if the timer has expired, the master node will indicate to the wireless device to release the SCG configuration upon resuming the SCG for the UE or moving the UE to the CONNECTED state.

In an alternative embodiment, the second message may comprise an indication that the secondary node is releasing resources associated with the one or more layers of a radio connection between the secondary node and the wireless device. The indication may equivalently indicate that the resources have been released or will be released. In the latter case, the second message may comprise an indication of a time at which the resources will be released.

The second message may be transmitted by the secondary node upon a determination that the resources are required to service one or more other wireless devices seeking service from the secondary node. For example, the second message may be triggered based on the traffic flowing on the secondary node (e.g., the number of connections or active connections, or the amount of data flowing through the secondary node). If the traffic exceeds a threshold, the second message may be triggered so that the secondary node has sufficient available resources to serve other wireless devices.

The second message may comprise an SN Modification Required message (also known as S-NODE Modification Required). The indication may comprise an information element set to a particular value. For example, the I E may be a Lower Layer Presence Status Change IE. The particular value may be repurposed from pre-defined values for the IE (such as “release lower layers”), or a new value dedicated for the purpose of indicating that the secondary node is releasing the resources.

While the wireless device is in the inactive mode, or while the radio connection between the wireless device and the secondary node is suspended, the master node may refrain from informing the wireless device the secondary node is releasing resources associated with the one or more layers of the radio connection between the secondary node and the wireless device. Responsive to a determination that the radio connection between the secondary node and the wireless device is to be resumed, and that the resources associated with one or more layers of the radio connection between the secondary node and the wireless device are released, the master node may cause transmission to the wireless device of a further message, the further message comprising an indication that the radio connection between the wireless device and the secondary node is to be reconfigured.

In step 2006, the master node receives a third message from the secondary node. Step 2006 may correspond to step 820 described above.

The third message comprises an indication that the secondary node is re-allocating resources to the one or more layers of the radio connection between the secondary node and the wireless device. The indication may equivalently indicate that the resources have been re-allocated or will be re-allocated. In the latter case, the third message may comprise an indication of a time at which the resources will be re-allocated.

The third message may comprise a further SN Modification Required message (also known as S-NODE Modification Required). The indication may comprise an information element set to a particular value. For example, the I E may be a Lower Layer Presence Status Change IE. The particular value may be repurposed from pre-defined values for the IE (such as “re-establish lower layers”), or a new value dedicated for the purpose of indicating that the secondary node is re-allocating the resources.

Responsive to a determination that the radio connection between the secondary node and the wireless device is to be resumed, and that the resources associated with one or more layers of the radio connection between the secondary node and the wireless device have been re-allocated, the master node need not (and does not) take any action to reconfigure the SCG connections of the wireless device once the connection between the secondary node and the wireless device resumes.

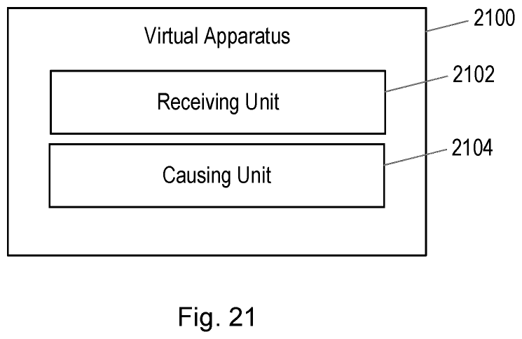

FIG. 21 illustrates a schematic block diagram of an apparatus 2100 in a wireless network (for example, the wireless network shown in FIG. 9). The apparatus may be implemented in a network node (e.g., network node 960 shown in FIG. 9 and/or master node 804 shown in FIG. 8). Apparatus 2100 is operable to carry out the example method described with reference to FIG. 20 and possibly any other processes or methods disclosed herein. It is also to be understood that the method of FIG. 20 is not necessarily carried out solely by apparatus 2100. At least some operations of the method can be performed by one or more other entities.

Virtual Apparatus 2100 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving unit 2102 and causing unit 2104, and any other suitable units of apparatus 2100 to perform corresponding functions according one or more embodiments of the present disclosure.

As illustrated in FIG. 21, apparatus 2100 includes receiving unit 2102 and causing unit 2104. In one embodiment, receiving unit 2102 is configured to receive, from a secondary node, a message comprising an indication that the secondary node is releasing resources associated with one or more layers of a radio connection between the secondary node and the wireless device.

Additionally or alternatively, causing unit 2104 is configured to cause transmission, to a secondary node of the one or more secondary nodes, of a message comprising a first indication that a radio connection between the secondary node and the wireless device is suspended, and a second indication of a time period for which the secondary node is to maintain an allocation of resources associated with one or more layers of the radio connection between the secondary node and the wireless device despite the suspension of that radio connection.

The one or more layers may comprise a subset of the total layers of the radio connection between the secondary node and the wireless device, such as an integer number of lowest layers.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

For the avoidance of doubt, the following enumerated statements set out embodiments of the disclosure.

### Group A Embodiments

1. A method performed by a base station of a wireless communication network, the base station being configured as a secondary node for a wireless device having dual- or multi-connectivity to the wireless communication network via a master node and one or more secondary nodes comprising the base station, the method comprising:
causing transmission of a message to the master node, the message comprising an indication that the base station is releasing resources associated with one or more layers of a radio connection between the base station and the wireless device.

2. The method of embodiment 1, wherein the one or more layers comprise a subset of the total layers of the radio connection between the base station and the wireless device.

3. The method of embodiment 2, wherein the base station maintains a context or configuration for one or more layers not belonging to the subset.

4. The method of any preceding embodiment, wherein the one or more layers comprise the one or more lowest layers of the radio connection between the base station and the wireless device.

5. The method of any preceding embodiment, wherein the one or more layers comprise one or more of: a radio link control, RLC, layer; a medium access control, MAC, layer; and a physical, PHY, layer.

6. The method of any preceding embodiment, wherein the one or more layers comprise one or more of: a packet data convergence protocol, PDCP, layer; and a service data adaptation protocol, SDAP, layer.

7. The method of any preceding embodiment, wherein the message is transmitted over a direct interface between the master node and the base station.

8. The method of any preceding embodiment, wherein the message comprises an SN Modification Required message.

9. The method of any preceding embodiment, wherein the indication comprises an information element set to a particular value.

10. The method of embodiment 9, wherein the information element comprises a Lower Layer Presence Status Change information element.

11. The method of any preceding embodiment, wherein the base station causes transmission of the message to the master node while the wireless device is in an inactive mode, or while the radio connection between the wireless device and the base station is suspended.

12. The method of any preceding embodiment, wherein the base station causes transmission of the message to the master node upon a determination that the resources associated with the one or more layers of the radio connection between the base station and the wireless device are required for allocation to one or more radio connections with one or more other wireless devices.

13. The method of any preceding embodiment, wherein the message is a first message, and further comprising causing transmission of a second message to the master node, the second message comprising an indication that the base station is re-allocating resources to the one or more layers of the radio connection between the base station and the wireless device.

14. The method of embodiment 13, wherein the second message comprises an SN Modification Required message.

15. A method performed by a base station of a wireless communication network, the base station being configured as a secondary node for a wireless device having dual- or multi-connectivity to the wireless communication network via a master node and one or more secondary nodes comprising the base station, the method comprising:
receiving, from the master node, a message comprising a first indication that a radio connection between the base station and the wireless device is suspended, and a second indication of a time period for which the base station is to maintain an allocation of resources associated with one or more layers of the radio connection between the base station and the wireless device despite the suspension of that radio connection.

16. The method of embodiment 15, wherein the message is a first message, and further comprising causing transmission of a second message to the master node, the second message comprising an indication of a time period for which the base station intends to maintain the allocation of resources associated with one or more layers of the radio connection between the base station and the wireless device.

17. The method of embodiment 16, wherein the second message comprises an SN Modification Required message or an SN Modification Request Acknowledge message.

18. The method of any one of embodiments 15 to 17, wherein the one or more layers comprise a subset of the total layers of the radio connection between the base station and the wireless device.

19. The method of any one of embodiments 15 to 18, wherein the one or more layers comprise the one or more lowest layers of the radio connection between the base station and the wireless device.

20. The method of any one of embodiments 15 to 19, wherein the one or more layers comprise one or more of: a radio link control, RLC, layer; a medium access control, MAC, layer; and a physical, PHY, layer.

21. The method of any one of embodiments 15 to 20, wherein the one or more layers comprise one or more of: a packet data convergence protocol, PDCP, layer; and a service data adaptation protocol, SDAP, layer.

22. The method of any one of embodiments 15 to 21, wherein the message is transmitted over a direct interface between the master node and the base station.

23. The method of any one of embodiments 15 to 22, wherein the first message comprises an SN Modification Request message.

24. The method of any one of embodiments 15 to 23, wherein the first indication comprises an information element set to a particular value.

25. The method of embodiment 24, wherein the information element comprises a Lower Layer Presence Status Change information element.

26. The method of any one of embodiments 15 to 25, wherein the base station receives the message from the master node while the wireless device is in an inactive mode, or while the radio connection between the wireless device and the base station is suspended.

### Group B Embodiments

27. A method performed by a base station of a wireless communication network, the base station being configured as a master node for a wireless device having dual- or multi-connectivity to the wireless communication network via the base station and one or more secondary nodes, the method comprising:
receiving a message from a secondary node of the one or more secondary nodes, the message comprising an indication that the secondary node is releasing resources associated with one or more layers of a radio connection between the secondary node and the wireless device.

28. The method of embodiment 27, wherein the one or more layers comprise a subset of the total layers of the radio connection between the secondary node and the wireless device.

29. The method of embodiment 28, wherein the secondary node maintains a context or configuration for one or more layers not belonging to the subset.

30. The method of any one of embodiments 27 to 29, wherein the one or more layers comprise the one or more lowest layers of the radio connection between the secondary node and the wireless device.

31. The method of any one of embodiments 27 to 30, wherein the one or more layers comprise one or more of: a radio link control, RLC, layer; a medium access control, MAC, layer; and a physical, PHY, layer.

32. The method of any one of embodiments 27 to 31, wherein the one or more layers comprise one or more of: a packet data convergence protocol, PDCP, layer; and a service data adaptation protocol, SDAP, layer.

33. The method of any one of embodiments 27 to 32, wherein the message is received over a direct interface between the base station and the secondary node.

34. The method of any one of embodiments 27 to 33, wherein the message comprises an SN Modification Required message.

35. The method of any one of embodiments 27 to 34, wherein the indication comprises an information element set to a particular value.

36. The method of embodiment 35, wherein the information element comprises a Lower Layer Presence Status Change information element.

37. The method of any one of embodiments 27 to 36, wherein the base station receives the message from the secondary node while the wireless device is in an inactive mode, or while the radio connection between the wireless device and the base station is suspended.

38. The method of embodiment 37, further comprising, while the wireless device is in the inactive mode, or while the radio connection between the wireless device and the base station is suspended, refraining from informing the wireless device the secondary node is releasing resources associated with the one or more layers of the radio connection between the secondary node and the wireless device.

39. The method of any one of embodiments 27 to 38, wherein the message is a first message, and further comprising, responsive to a determination that the radio connection between the secondary node and the wireless device is to be resumed, and that the resources associated with one or more layers of the radio connection between the secondary node and the wireless device are released, causing transmission to the wireless device of a second message, the second message comprising an indication that the radio connection between the wireless device and the secondary node is to be reconfigured.

40. The method of any one of embodiments 27 to 39, wherein the message is a first message, and further comprising receiving a third message from the secondary node, the third message comprising an indication that the secondary node is re-allocating resources to the one or more layers of the radio connection between the secondary node and the wireless device.

41. The method of embodiment 40, wherein the third message comprises an SN Modification Required message.

42. A method performed by a base station of a wireless communication network, the base station being configured as a master node for a wireless device having dual- or multi-connectivity to the wireless communication network via the base station and one or more secondary nodes, the method comprising:
causing transmission, to a secondary node of the one or more secondary nodes, of a message comprising a first indication that a radio connection between the secondary node and the wireless device is suspended, and a second indication of a time period for which the secondary node is to maintain an allocation of resources associated with one or more layers of the radio connection between the secondary node and the wireless device despite the suspension of that radio connection.

43. The method of embodiment 42, wherein the message is a first message, and further comprising receiving a second message from the secondary node, the second message comprising an indication of a time period for which the secondary node intends to maintain the allocation of resources associated with one or more layers of the radio connection between the secondary node and the wireless device.

44. The method of embodiment 43, wherein the second message comprises an SN Modification Required message or an SN Modification Request Acknowledge message.

45. The method of any one of embodiments 42 to 44, wherein the one or more layers comprise a subset of the total layers of the radio connection between the secondary node and the wireless device.

46. The method of any one of embodiments 42 to 45, wherein the one or more layers comprise the one or more lowest layers of the radio connection between the secondary node and the wireless device.

47. The method of any one of embodiments 42 to 46, wherein the one or more layers comprise one or more of: a radio link control, RLC, layer; a medium access control, MAC, layer; and a physical, PHY, layer.

48. The method of any one of embodiments 42 to 47, wherein the one or more layers comprise one or more of: a packet data convergence protocol, PDCP, layer; and a service data adaptation protocol, SDAP, layer.

49. The method of any one of embodiments 42 to 48, wherein the first message is received over a direct interface between the base station and the secondary node.

50. The method of any one of embodiments 42 to 49, wherein the first message comprises an SN

Modification Request message.

51. The method of any one of embodiments 42 to 50, wherein the first indication comprises an information element set to a particular value.

52. The method of embodiment 51, wherein the information element comprises a Lower Layer Presence

Status Change information element.

53. The method of any one of embodiments 42 to 52, wherein the base station causes the message to be transmitted to the secondary node while the wireless device is in an inactive mode, or while the radio connection between the wireless device and the secondary node is suspended.

### Group C Embodiments

54. A base station, the base station comprising:
processing circuitry configured to perform any of the steps of any of the Group A or Group B embodiments;
power supply circuitry configured to supply power to the base station.

55. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group A or Group B embodiments.

56. The communication system of the previous embodiment further including the base station.

57. The communication system of the previous 2 embodiments, further including the UE, wherein the UE is configured to communicate with the base station.

58. The communication system of the previous 3 embodiments, wherein:
the processing circuitry of the host computer is configured to execute a host application, thereby providing the user data; and
the UE comprises processing circuitry configured to execute a client application associated with the host application.

59. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group A or Group B embodiments.

60. The method of the previous embodiment, further comprising, at the base station, transmitting the user data.

61. The method of the previous 2 embodiments, wherein the user data is provided at the host computer by executing a host application, the method further comprising, at the UE, executing a client application associated with the host application.

62. A user equipment (UE) configured to communicate with a base station, the UE comprising a radio interface and processing circuitry configured to performs the of the previous 3 embodiments.

63. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group A or Group B embodiments.

64. The communication system of the previous embodiment further including the base station.

65. The communication system of the previous 2 embodiments, further including the UE, wherein the UE is configured to communicate with the base station.

66. The communication system of the previous 3 embodiments, wherein:
the processing circuitry of the host computer is configured to execute a host application;
the UE is configured to execute a client application associated with the host application, thereby providing the user data to be received by the host computer.

1-48. (canceled)

49. A method performed by a base station of a wireless communication network, the base station being configured as a secondary node for a wireless device having dual- or multi-connectivity to the wireless communication network via a master node and one or more secondary nodes comprising the base station, the method comprising:
causing transmission of a message to the master node, the message comprising an indication that the base station is releasing resources associated with one or more layers of a radio connection between the base station and the wireless device.

50. The method of claim 49, wherein the one or more layers comprise a subset of the total layers of the radio connection between the base station and the wireless device.

51. The method of claim 50, wherein the base station maintains a context or configuration for one or more layers not belonging to the subset.

52. The method of claim 49, wherein the base station causes transmission of the message to the master node while the wireless device is in an inactive mode, or while the radio connection between the wireless device and the base station is suspended.

53. The method of claim 49, wherein the base station causes transmission of the message to the master node upon a determination that the resources associated with the one or more layers of the radio connection between the base station and the wireless device are required for allocation to one or more radio connections with one or more other wireless devices.

54. The method of claim 49:
wherein the message is a first message; and
further comprising causing transmission of a second message to the master node, the second message comprising an indication that the base station is re-allocating resources to the one or more layers of the radio connection between the base station and the wireless device.

55. A method performed by a base station of a wireless communication network, the base station being configured as a secondary node for a wireless device having dual- or multi-connectivity to the wireless communication network via a master node and one or more secondary nodes comprising the base station, the method comprising:
receiving, from the master node, a message comprising a first indication that a radio connection between the base station and the wireless device is suspended, and a second indication of a time period for which the base station is to maintain an allocation of resources associated with one or more layers of the radio connection between the base station and the wireless device despite the suspension of that radio connection.

56. The method of claim 55:
wherein the message is a first message; and
further comprising causing transmission of a second message to the master node, the second message comprising an indication of a time period for which the base station intends to maintain the allocation of resources associated with one or more layers of the radio connection between the base station and the wireless device.

57. The method of claim 55, wherein the one or more layers comprise a subset of the total layers of the radio connection between the base station and the wireless device.

58. The method of claim 55, wherein the base station receives the message from the master node while the wireless device is in an inactive mode, or while the radio connection between the wireless device and the base station is suspended.

59. A base station, the base station being configured as a secondary node for a wireless device having dual- or multi-connectivity to a wireless communication network via a master node and one or more secondary nodes comprising the base station, the base station comprising:
interface circuitry configured to communicate with other nodes of the wireless communication network;
processing circuitry operatively connected to the interface circuitry and configured to cause the base station to cause transmission of a message to the master node, the message comprising an indication that the base station is releasing resources associated with one or more layers of a radio connection between the base station and the wireless device.

60. The base station of claim 59, wherein the one or more layers comprise a subset of the total layers of the radio connection between the base station and the wireless device.

61. The base station of claim 60, wherein the processing circuitry is configured to cause the base station to maintain a context or configuration for one or more layers not belonging to the subset.

62. The base station of claim 59, wherein the processing circuitry is configured to cause the base station to cause transmission of the message to the master node while the wireless device is in an inactive mode, or while the radio connection between the wireless device and the base station is suspended.

63. The base station of claim 59, wherein the processing circuitry is configured to cause the base station to cause transmission of the message to the master node upon a determination that the resources associated with the one or more layers of the radio connection between the base station and the wireless device are required for allocation to one or more radio connections with one or more other wireless devices.

64. The base station of claim 59:
wherein the message is a first message; and
wherein the processing circuitry is configured to cause the base station to cause transmission of a second message to the master node, the second message comprising an indication that the base station is re-allocating resources to the one or more layers of the radio connection between the base station and the wireless device.

65. A base station, the base station being configured as a secondary node for a wireless device having dual- or multi-connectivity to a wireless communication network via a master node and one or more secondary nodes comprising the base station, the base station comprising:
interface circuitry configured to communicate with other nodes of the wireless communication network;
processing circuitry operatively connected to the interface circuitry and configured to cause the base station to receive, from the master node, a message comprising a first indication that a radio connection between the base station and the wireless device is suspended, and a second indication of a time period for which the base station is to maintain an allocation of resources associated with one or more layers of the radio connection between the base station and the wireless device despite the suspension of that radio connection.

66. The base station of claim 65:
wherein the message is a first message; and
wherein the processing circuitry is configured to cause the base station to cause transmission of a second message to the master node, the second message comprising an indication of a time period for which the base station intends to maintain the allocation of resources associated with one or more layers of the radio connection between the base station and the wireless device.

67. The base station of claim 65, wherein the one or more layers comprise a subset of the total layers of the radio connection between the base station and the wireless device.

68. The base station of claim 65, wherein the processing circuitry is configured to cause the base station to receive the message from the master node while the wireless device is in an inactive mode, or while the radio connection between the wireless device and the base station is suspended.
